(19) United States
(12) Patent Application Publication
(10) Pub. No.: US 2021/0371105 A1
(43) Pub. Date: Dec. 2, 2021

(54) SYSTEMS AND METHODS FOR OPTIMIZATION OF PACKAGING LARGE IRREGULAR PAYLOADS FOR SHIPMENT BY AIR VEHICLES

(71) Applicant: ZSM HOLDINGS LLC, Dover, DE (US)

(72) Inventor: Scott David REWERTS, Summerfield, NC (US)

(21) Appl. No.: 17/403,088

(22) Filed: Aug. 16, 2021

Related U.S. Application Data
(63) Continuation of application No. PCT/US2020/049781, filed on Sep. 8, 2020.
(60) Provisional application No. 62/896,533, filed on Sep. 5, 2019.
(60) Provisional application No. 62/896,529, filed on Sep. 5, 2019.
(60) Provisional application No. 62/896,519, filed on Sep. 5, 2019.
(60) Provisional application No. 62/938,853, filed on Nov. 21, 2019.

(51) Int. Cl. B64D 9/00; G06T 15/10; G06T 15/08; G06K 9/00

(52) U.S. Cl. CPC B64D 9/00; G06K 9/00832; G06T 15/08; G06T 15/10

(57) ABSTRACT

A method of optimizing a packaging of large irregular objects is disclosed. The method includes receiving a first 3D object and a second 3D object, calculating, for an orientation of the first object and the second object, a minimum clearance between the objects, the orientation of the objects including a plurality of degrees of freedom, storing the orientation of the second object and calculated minimum clearance as a payload orientation, and adjusting each degree of freedom of the second object through a series of nested loops. Each loop of the nested loops increments a degree of freedom and, for each increment, repeats the calculating, storing for a corresponding orientation of the second object. The method can include receiving a constraint and, for each increment, comparing the calculated clearance to the constraint and storing the orientation of the second object only if the calculated clearance satisfies the constraint.

### CROSS-REFERENCE TO RELATED APPLICATIONS

This application claims priority to and the benefit of each of U.S. Provisional Application Ser. No. 62/896,519, filed Sep. 5, 2019 and entitled SYSTEM AND METHOD FOR OPTIMIZATION OF PACKAGING LARGE IRREGULAR PAYLOADS FOR SHIPMENT BY AIR VEHICLES, and from U.S. Provisional Application Ser. No. 62/938,853 filed Nov. 21, 2019 and entitled KINKED LONG AIRCRAFT FUSELAGE CONFIGURATION FOR AVOIDING TAIL STRIKE WHILE ALLOWING LONG PAYLOADS, and from U.S. Provisional Application Ser. No. 62/896,529 filed Sep. 5, 2019 and entitled CARGO AIRCRAFT TOOL TO PERMIT WIND TURBINE BLADE PAYLOAD ARTICULATION DURING LOADING/UNLOADING, and from U.S. Provisional Application Ser. No. 62/896,533, filed Sep. 5, 2019 and entitled METHODS FOR PACKAGING AND PLACING ELONGATED CARGOS WITHIN A VEHICLE.

### FIELD

The present disclosure relates to systems and methods for optimization of multi-object cargo orientations for transport in large, transport-category aircraft, capable of moving oversized cargo not traditionally shippable by air.

### BACKGROUND

Renewable energy remains an increasingly important resource year-over-year. While there are many forms of renewable energy, wind energy has increased an average of about 19 percent annually since 2007. The increase in global demand in recent years for more wind energy has catalyzed drastic advances in wind turbine technology, including the development of larger, better-performing wind turbines. Better-performing wind turbines can at least sometimes mean larger turbines, as generally turbines with larger rotor diameters can capture more wind energy. As turbines continue to improve in performance and efficiency, more and more wind farm sites become viable both onshore and offshore. These sites may be existing sites, where older turbines need replacement by better-performing, more efficient turbines, and new sites.

A limiting factor to allow for the revitalization of old sites and development of new sites is transporting the wind turbines, and related equipment, to the sites. Wind turbine blades are difficult to transport long distances due to the terrestrial limitations of existing air vehicles and roadway infrastructures. Onshore transportation has traditionally required truck or rail transportation on existing infrastructure. Both are limited by height and width of tunnels and bridges. Road transport has additional complications of lane width, road curvature, and the need to pass through urban areas that may require additional permitting and logistics, among other complications. Offshore transportation by ship is equally, if not more so, limiting. For example, delivery of parts can be limited to how accessible the offshore location is by ship due to various barriers (e.g., sand bars, coral reefs) and the like in the water and surrounding areas, as well as the availability of ships capable of handling such large structures.

Whether onshore or offshore, the road vehicle or ship options for transporting such equipment has become more limited, particularly as the size of wind turbines increase. Delivery is thus limited by the availability of vehicles and ships capable of handling such large structures. The very long lengths of wind turbine blades (some are presently 90 meters long, 100 meters long, or even longer) make conventional transportation by train, truck, or ship very difficult and complicated. Unfortunately, the solution is not as simple as making transportation vehicles longer and/or larger. There are a variety of complications that present themselves as vehicles are made longer and/or larger, including but not limited to complications of: load balancing of the vehicle; load balancing the equipment being transported; load balancing the two with respect to each other; handling, maneuverability, and control of the vehicle; and other complications that would be apparent to those skilled in the art.

Further, whether onshore or offshore, delivery of parts can be slow and severely limited by the accessibility of the site. Whether the site being developed is old or new, the sites can often be remote, and thus not near suitable transportation infrastructure. The sites may be far away from suitable roads and rails (or other means by which cargo may be transported) to allow for easy delivery of cargo for use in building the turbines at the site and/or other equipment used in developing the site. New sites are often in areas without any existing transportation infrastructure at all, thus requiring new construction and special equipment. Ultimately, transportation logistics become cost prohibitive, resulting in a literal and figurative roadblock to further advancing the use of wind energy on a global scale.

A critical consideration for air vehicle is the required amount of cargo space to reserve for payload. This is true regardless of whether the vehicle carries its cargo internally or externally. If the air vehicle carries cargo internally, then for any particular nondimensional shape of the air vehicle, increasing the dimensional size of cargo will result in a required increase in the size of the air vehicle, which causes increases in aerodynamic drag, structural weight, and additional drag/weight/cost to meet additional requirements for the enclosed volume (e.g., environmental control, ventilation, cargo restraint, crashworthiness, and the like). A nondimensional shape is a term often used in aerospace in which a shape has all spatial dimensions and defining coordinates divided out by a scaling constant that is characteristic of the shape. For example, airfoils are often examined non-dimensionally by considering their shape divided by the chord length. Essentially, a larger cargo will require an increase in the size of the aircraft.

Furthermore, if two or more cargo objects, such as wind turbine blades, are not packaged optimally for transportation, a larger than necessary cargo aircraft will be required for transportation. This results in increased weight of the aircraft, greater cost to build the aircraft, greater fuel consumption, greater airport restrictions, and the like. Therefore, during the design phase, it is highly desirable to minimize air vehicle drag, weight, and cost, and to improve air vehicle balance, stability, and controllability by minimizing vehicle dimensions, and by extension, packaged payload dimensions. Even once vehicle dimensions are set, a smaller loaded payload package offers a higher likelihood of fitting into the vehicle, plus faster loading and unloading, more clearance to reduce the likelihood of collisions and related damage, and greater accessibility in the loaded cargo bay.

Accordingly, there is a need for ways to calculate optimized orientations of multi-object cargo payloads to maximize their packing efficiency.

### SUMMARY

The present disclosure provides systems and methods for optimizing the orientation of multi-object cargo payloads to maximize the packing efficiency and, in some instances, enable the carrying of cargo payloads in an optimized orientation with respect to an interior cargo bay. These and other advantages will be apparent from the following detailed description and accompanying figures.

Examples of the present disclosure provide a process involving iterative optimization of the spatial requirements of multiple large, irregularly-shaped payloads, which allows a reduction in the required space to ship those payloads within an air vehicle. Examples include optimizing the orientation of one 3D object with respect to another to determine one or more optimized packaging arrangement. Examples also include, given a known set of objects, or package of objects, perturbing the orientation of the package relative to a known fixed interior cargo bay geometry to: (1) maximize the minimum distance between the object and the interior cargo bay geometry; and/or (2) in some instances, center the payload in the cargo bay. Examples also include, given either a set of objects, or a package of objects, perturbing the orientations of the objects or package relative to a cargo bay centerline for an unknown and/or as-yet-un-designed interior cargo bay geometry to minimize the maximum distance between the objects payload and the cargo bay centerline. That is, to essentially center the payload in an interior cargo bay that has not really been designed, but for which an approximate centerline is known to, for example, determine a reasonable design of a cargo bay for holding objects of an optimized packaging.

Examples of the present disclosure include a computer-implemented method of optimizing a packaging orientation of large irregular payloads. The method includes receiving, via an input operated by a processor, a first 3D surface geometry of a first object, a second 3D surface geometry of a second object, and a minimum clearance constraint, calculating, using a processor, for an orientation of the first 3D surface geometry and an orientation of the second 3D surface geometry, a minimum clearance between the first 3D surface geometry and the second 3D surface geometry, the orientation of the second 3D surface geometry comprising three translational degrees of freedom and three rotational degrees of freedom, comparing, using a processor, the calculated minimum clearance to the minimum clearance constraint, storing, in a memory location in electrical communication with the processor, the orientation of the second 3D surface geometry and calculated minimum clearance if the calculated minimum clearance satisfies the minimum clearance constraint based on the comparing as a payload orientation with respect to the orientation of the first 3D surface geometry, adjusting, using a processor, each of the three translational degrees of freedom and three rotational degrees of freedom of the second 3D surface geometry through a series of six nested loops, each of the six nested loops adjusting a corresponding degree of freedom through a corresponding range of increments in a separate layer of the series and, for each increment, repeating the calculating, comparing, and storing for a corresponding orientation of the second 3D surface geometry, and outputting, via a processor, the stored payload orientations.

In some examples, the calculating includes calculating for the orientation of the first 3D surface geometry and the orientation of the second 3D surface geometry a 3D convex hull volume of the combined first and second 3D surface geometries, and the storing includes storing the calculated convex hull volume. In some examples, the method includes, after the adjusting, filtering the stored corresponding orientations of the second 3D surface geometry based on the calculated convex hull volume. In some examples, calculating the 3D convex hull volume includes: (a) calculating a plurality of 2D convex hull areas in a corresponding plurality of 2D planes each intersecting at least one of the first and second 3D surface geometries along a total length of the first and second 3D surface geometries, and (b) integrating the plurality of 2D convex hull areas along the total length. Each of the plurality of 2D convex hull areas can be calculated using Green's theorem. In some examples, calculating the 3D convex hull volume includes calculating a bi-tangential connection between each of the first and second 3D surface geometries in a corresponding one of the plurality of 2D planes to build each of the plurality of 2D convex hull areas.

In some examples, each of the first and second 3D surface geometries defines a volume and the combined volumes of the first and second 3D surface geometries defines a total object volume, where the calculating includes calculating a convex hull volume ratio between the calculated convex hull volume and the total object volume, and where the storing includes storing the convex hull volume ratio with each payload orientation. The receiving can include receiving a convex hull constraint, where the comparing includes comparing the calculated convex hull volume ratio to the convex hull constraint, and where the storing includes storing the convex hull volume ratio and payload orientation if both the calculated minimum clearance satisfies the minimum clearance constraint and the calculated convex hull volume ratio satisfies the convex hull constraint based on the comparing.

In some examples, the receiving includes receiving a range constraint for at least one of the corresponding range of increments, where the adjusting includes at least one of the corresponding range of increments being based on the range constraint.

In some examples, at least one of the corresponding range of increments includes increments of a first spacing, the method can include after the adjusting and for each stored payload orientation, repeating the adjusting with an optimized range of increments in place of the corresponding range, the optimized range including increments of a second spacing, the second spacing being smaller than the first spacing, and the optimized range defining a reduced range compared to the corresponding range, the reduced range including the orientation of a corresponding one of each stored payload.

The receiving can include receiving a cargo bay 3D surface geometry of a cargo bay volume and a minimum payload clearance constraint, where the cargo bay 3D surface geometry defines a fixed cargo bay orientation, where the orientation of the first 3D surface geometry includes three translational degrees of freedom and three rotational degrees of freedom, where the calculating includes calculating for the orientation of the first 3D surface geometry and the orientation of the second 3D surface geometry a minimum payload clearance between an exterior of the first and second 3D surface geometries and an interior of the cargo bay 3D surface, where the comparing includes comparing the calculated minimum payload clearance to the minimum payload clearance constraint where the storing includes storing: (a) the orientations of the first and second 3D surfaces with respect to the fixed cargo bay orientation, (b) the calculated minimum clearance, and (c) the minimum payload clearance as the payload orientation if both: (i) the calculated minimum clearance satisfies the minimum clearance constraint and (ii) the calculated minimum payload clearance satisfies the minimum payload clearance constrained based on the comparing. Where the adjusting includes adjusting each of the three translational degrees of freedom and three rotational degrees of freedom of the first 3D surface geometry through an additional series of six nested loops, each of the six nested loops of the additional series adjusting a corresponding degree of freedom through a corresponding range of increments in a separate layer of the additional series and, for each increment, repeating the calculating, comparing, and storing for a corresponding orientation of the first 3D surface geometry such that the series and the additional series form the single nested group.

In some examples, the cargo bay 3D surface geometry defines a centerline extending from a first end of the cargo bay volume to a second opposite end of the cargo bay volume, where the receiving includes receiving a maximum centerline deviation constraint, where the calculating includes calculating for the orientation of the first 3D surface geometry and the orientation of the second 3D surface geometry a maximum distance between an exterior of the first and second 3D surface geometries and the centerline measured substantially perpendicular to the centerline, where the comparing includes comparing the calculated maximum distance to the maximum centerline deviation constraint payload clearance constraint, and where the storing further includes storing (a), (b), and (c) if the calculated maximum distance satisfies the maximum centerline deviation constrained based on the comparing in addition to (i) and (ii).

The cargo bay 3D surface geometry can define a cargo door opening into the interior of the cargo bay 3D surface geometry, where the receiving includes receiving a minimum loading clearance constraint and the method includes simulating, using a processor, for each stored orientation of the first and second 3D surface geometries, a loading operation along an input path of a 3D payload object having an exterior surface defined by the first and second 3D surface geometries in their stored orientation, calculating a minimum loading clearance between the exterior surface of the 3D payload and the interior of the cargo bay 3D surface geometry, comparing the calculated minimum loading clearance to the minimum loading clearance constraint, and outputting each 3D payload object that satisfies the minimum loading clearance constraint based on the comparing. In some examples, the calculating a minimum loading clearance between the exterior surface of the 3D payload and the interior of the cargo bay 3D surface geometry occurs during the simulating. In some examples, the receiving includes receiving an initial orientation of the first 3D surface geometry and an initial orientation of the second 3D surface geometry, and where the initial orientations of both the first and second 3D surface geometries are disposed inside the cargo bay 3D surface geometry in the fixed cargo bay orientation, the first and second 3D surface geometries being in the respective initial orientations before the adjusting.

The input can receive at least one or more 3D surface geometries of at least one or more objects, where the calculating includes calculating a minimum clearance between the first 3D surface geometry, the second 3D surface geometry, and each of the at least one or more 3D surface geometries for an orientation of the at least one or more 3D surface geometries, the orientation of the each of the at least one or more 3D surface geometries including three translational degrees of freedom and three rotational degrees of freedom, where the storing includes storing the orientation of the at least one or more 3D surface geometries in the payload orientation, and where the adjusting includes adjusting each of the three translational degrees of freedom and three rotational degrees of freedom of the at least one or more 3D surface geometries through a further series of six nested loops per each object of the at least one or more objects, each of the six nested loops of each further series adjusting a corresponding degree of freedom through a corresponding range of increments in a separate layer of the further series and, for each increment, repeating the calculating, comparing, and storing for a corresponding orientation of the 3D surface geometry of the at least one or more 3D surface geometries such that each series of the further series and the series form the single nested group, the single nested group further including the additional series when the additional series is present.

In some examples, the adjusting includes, for at least one of the nested loops, adjusting the corresponding range of increments based on a trend of two or more previously calculated minimum clearances. In some examples, the first object includes a first wind turbine blade and the second object includes a second wind turbine blade. In some examples, when at least one or more objects are provided, a third object of the at least one or more objects is a third wind turbine blade. In some examples, a fourth object of the at least one or more objects is a fourth wind turbine blade.

Another example of the present disclosure is a computer system including an input module configured to receive a first 3D surface geometry of a first object, a second 3D surface geometry of a second object, and a minimum clearance constraint, a calculator module configured to calculate, for an orientation of the first 3D surface geometry and an orientation of the second 3D surface geometry, a minimum clearance between the first 3D surface geometry and the second 3D surface geometry, the orientation of the second 3D surface geometry including three translational degrees of freedom and three rotational degrees of freedom, a comparer module configured to compare the calculated minimum clearance to the minimum clearance constraint, a memory module configured to store the orientation of the second 3D surface geometry and calculated minimum clearance if the calculated minimum clearance satisfies the minimum clearance constraint based on the comparing as a payload orientation with respect to the orientation of the first 3D surface geometry, an adjuster module configured to adjust each of the three translational degrees of freedom and three rotational degrees of freedom of the second 3D surface geometry through a series of six nested loops, each of the six nested loops adjusting a corresponding degree of freedom through a corresponding range of increments in a separate layer of the series and, for each increment, interfacing with the calculator module, the comparer module, and the memory module in order to repeat a calculating, comparing, and storing operation for a corresponding orientation of the second 3D surface geometry, and an output configured to output the stored payload orientations. The computer system can have, for example, any of the features described herein with respect to any of the methods and the computer program products.

Yet another example of the present disclosure is computer program product, including a tangible, non-transient computer usable medium having computer readable program code thereon. The computer readable program code includes program code configured to receive, via an input operated by a processor, a first 3D surface geometry of a first object, a second 3D surface geometry of a second object, and a minimum clearance constraint, calculate, using a processor, for an orientation of the first 3D surface geometry and an orientation of the second 3D surface geometry, a minimum clearance between the first 3D surface geometry and the second 3D surface geometry, the orientation of the second 3D surface geometry including three translational degrees of freedom and three rotational degrees of freedom, compare, using a processor, the calculated minimum clearance to the minimum clearance constraint, store, in a memory location in electrical communication with the processor, the orientation of the second 3D surface geometry and calculated minimum clearance if the calculated minimum clearance satisfies the minimum clearance constraint based on the comparing as a payload orientation with respect to the orientation of the first 3D surface geometry, adjust, using a processor, each of the three translational degrees of freedom and three rotational degrees of freedom of the second 3D surface geometry through a series of six nested loops, each of the six nested loops adjusting a corresponding degree of freedom through a corresponding range of increments in a separate layer of the series and, for each increment, repeating the calculate, compare, and store operations for a corresponding orientation of the second 3D surface geometry, and output, via a processor, the stored payload orientations. The computer program product can include, for example, any of the features described herein with respect to any of the methods and the computer systems.

Still another example of the present disclosure is computer-implemented method of optimizing a packaging orientation of large irregular payloads. The method includes receiving, via an input operated by a processor, a first 3D surface geometry of a first object, and at least a second 3D surface geometry of a second object (but possibly numerous other 3D surface geometries of other objects), and a required inter-object clearance constraint, calculating, using a processor, for an orientation of the first 3D surface geometry and an orientation of each additional 3D surface geometry, an inter-object clearance between the first 3D surface geometry and each additional 3D surface geometry, the orientation of the additional surface geometries including three translational degrees of freedom and three rotational degrees of freedom between specified ranges for each degree of freedom, comparing, using a processor, the calculated inter-object clearance to the input required inter-object clearance constraint, storing, in a memory location in electrical communication with the processor, the orientation of each additional 3D surface and calculated inter-object clearance if the calculated inter-object clearance satisfies the required inter-object clearance constraint based on the comparing as a payload orientation with respect to the orientation of each 3D surface geometry, adjusting, using a processor, each of the three translational degrees of freedom and three rotational degrees of freedom of the additional 3D surface geometries through a series of six nested loops per geometry, each of the six nested loops adjusting a corresponding degree of freedom through a corresponding range of increments in a separate layer of the series and, for each increment, repeating the calculating, comparing, and storing for a corresponding orientation of the additional 3D surface geometries, and outputting, via a processor, the stored payload orientations.

In some examples, the calculating includes calculating for the orientation of the first 3D surface geometry and the orientation of the additional 3D surface geometries a 3D convex hull volume of the combined first and second 3D surface geometries, and where the storing includes storing the calculated convex hull volume. In some examples, after the adjusting, the method include filtering the stored corresponding orientations of the additional 3D surface geometries based on the calculated convex hull volume. In some examples, where calculating the 3D convex hull volume includes (a) calculating a plurality of 2D convex hull areas in a corresponding plurality of 2D planes each intersecting at least one of the 3D surface geometries along a total length of the 3D surface geometries, and (b) integrating the plurality of 2D convex hull areas along the total length to approximate the 3D convex hull efficiently and with reasonable accuracy, neglecting only to encapsulate curvature orthogonal to the 2D planes into the approximated 3D convex hull. In some examples, each of the plurality of 2D convex hull areas is calculated using Green's theorem. Calculating the 3D convex hull volume can include calculating a bi-tangential connection between each 3D surface geometry in a corresponding one of the plurality of 2D planes to build each of the plurality of 2D convex hull areas. In some examples, each of the first and additional 3D surface geometries defines a volume and the combined sum of the volumes of the first and additional 3D surface geometries defines a total object volume, which is obviously the minimum amount of volume which can be taken up by the combination of rigid objects, where the calculating includes calculating a convex hull volume ratio equal to the aforementioned calculated convex hull volume divided by the aforementioned total object volume, where the convex hull volume to total object volume ratio or “Convex Hull Volume Ratio Parameter” (CHVRP″) defines a type of packaging efficiency of the current packaging volume utilized divided by the minimum potential packaging volume for objects which nest together perfectly, such that perfect packages have CHVRP of unity and where the storing includes storing the CHVRP with each payload orientation. In some examples, the receiving includes determining a minimum convex hull ratio constraint by finding the minimum value of CHVRP over all orientations of all additional 3D surface geometries relative to the first 3D surface geometry, and where the storing includes storing the convex hull volume ratio and payload.

In some examples, the receiving includes receiving a range constraint for at least one of the corresponding range of increments for each degree of freedom and where the adjusting includes at least one of the corresponding range of increments being based on the range constraint for each degree of freedom. In some examples, at least one of the corresponding range of increments includes increments of a first spacing, the method further including after the adjusting and for each stored payload orientation, repeating the adjusting with an optimized range of increments in place of the corresponding range, the optimized range including increments of a second spacing, the second spacing being smaller than the first spacing, and the optimized range defining a reduced range compared to the corresponding range, the reduced range including the orientation of a corresponding one of each stored payload.

The receiving can include receiving a cargo bay 3D surface geometry of a known cargo bay volume, where the cargo bay 3D surface geometry defines a fixed cargo bay orientation, where the orientation of the first 3D surface geometry includes three translational degrees of freedom and three rotational degrees of freedom, where the calculating includes calculating for the orientation of each 3D surface geometry and a payload/cargo bay clearance between the exterior of the closest of the 3D surface geometries and an interior of the cargo bay 3D surface, where the storing includes storing (a) the orientations of each 3D surface with respect to the fixed cargo bay orientation, (b) the calculated inter-object clearance, and (c) the minimum payload/cargo bay clearance of the payload orientation, where the adjusting includes adjusting each of the three translational degrees of freedom and three rotational degrees of freedom of each 3D surface geometry through an additional series of six nested loops apiece, each of the six nested loops of the additional series adjusting a corresponding degree of freedom through a corresponding range of increments in a separate layer of the additional series and, for each increment, repeating the calculating, comparing, and storing for a corresponding orientation of each 3D surface geometry such that the series and the additional series form the single nested group. In some examples, an unknown cargo bay 3D surface geometry is defined only by a centerline extending from a first end of an otherwise unknown cargo bay volume to a second opposite end of an otherwise unknown cargo bay volume, where the calculating includes calculating for the orientation of each 3D surface geometry a maximum distance between the exterior of each 3D surface geometry and the centerline measured substantially perpendicular to the centerline, and where the storing further includes storing the calculated payload centerline deviation.

The cargo bay 3D surface geometry can define a cargo door opening into the interior of the cargo bay 3D surface geometry and the method includes simulating, using a processor, for each stored orientation of each 3D surface geometry, a loading or unloading operation of a 3D payload object having an exterior surface defined by each 3D surface geometry in numerous orientations along an input path during a loading and/or unloading operation, calculating a minimum loading clearance between the exterior surface of the 3D payload and the interior of the cargo bay 3D surface geometry, and outputting each 3D payload orientation with a corresponding calculated minimum loading clearance. In some examples, the calculating a minimum loading clearance between the exterior surface of the 3D payload and the interior of the cargo bay 3D surface geometry occurs during the simulating. In some examples, the receiving includes receiving an initial orientation of the first 3D surface geometry and an initial orientation of the second 3D surface geometry and where the initial orientations of both the first and second 3D surface geometries are disposed inside the cargo bay 3D surface geometry in the fixed cargo bay orientation, the first and second 3D surface geometries being in the respective initial orientations before the adjusting.

The input can receive at least one or more 3D surface geometries of at least one or more objects, where the calculating includes calculating a minimum clearance between the first 3D surface geometry, the second 3D surface geometry, and each of the at least one or more 3D surface geometries for an orientation of the at least one or more 3D surface geometries, the orientation of the each of the at least one or more 3D surface geometries including three translational degrees of freedom and three rotational degrees of freedom, where the storing includes storing the orientation of the at least one or more 3D surface geometries in the payload orientation, and where the adjusting includes adjusting each of the three translational degrees of freedom and three rotational degrees of freedom of the at least one or more 3D surface geometries through a further series of six nested loops per each object of the at least one or more objects, each of the six nested loops of each further series adjusting a corresponding degree of freedom through a corresponding range of increments in a separate layer of the further series and, for each increment, repeating the calculating, comparing, and storing for a corresponding orientation of the 3D surface geometry of the at least one or more 3D surface geometries such that each series of the further series and the series form the single nested group, the single nested group further including the additional series when the additional series is present. In some examples, the adjusting includes, for at least one of the nested loops, adjusting the corresponding range of increments based on a trend of two or more previously calculated interobject clearances.

### BRIEF DESCRIPTION OF DRAWINGS

This disclosure will be more fully understood from the following detailed description taken in conjunction with the accompanying drawings, in which:

FIG. 1A is an isometric view of one exemplary embodiment of an aircraft;

FIG. 1B is a side view of the aircraft of FIG. 1A;

FIG. 2A is an isometric view of the aircraft of FIG. 1A with a nose cone door in an open position to provide access to an interior cargo bay of the aircraft;

FIG. 2B is an isometric view of the aircraft of FIG. 2A with a payload being disposed proximate to the aircraft for loading into the interior cargo bay;

FIG. 2C is an isometric, partial cross-sectional view of the aircraft of FIG. 2B with the payload being partially loaded into the interior cargo bay;

FIG. 2D is an isometric, partial cross-sectional view of the aircraft of FIG. 3C with the payload being fully loaded into the interior cargo bay;

FIG. 3A is a side view of an alternative exemplary embodiment of an aircraft;

FIG. 3B is a side transparent view of the aircraft of FIG. 3A;

FIG. 3C is a side view of the aircraft of FIG. 3B in a take-off position;

FIG. 4 is the side view of the aircraft of FIG. 1A with some additional details removed for clarity;

FIG. 5 is a side cross-sectional view of the aircraft of FIG. 4, including an interior cargo bay of the aircraft;

FIG. 6 is the side cross-sectional view of the aircraft of FIG. 5 with an exemplary payload disposed in the interior cargo bay;

FIG. 7 is an illustration of two wind turbine blades as examples of two highly elongated and irregularly-shaped objects;

FIG. 8A is a schematic illustration of the six degrees of freedom of the wind turbine blades of FIG. 7 considered as variables to be adjusted and optimized by the payload orientation optimization routine;

FIG. 8B is an illustration of the tessellated 3D surface geometry of the two wind turbine blades of FIG. 7 arranged inside a tessellated 3D surface geometry of an interior cargo bay of the aircraft of FIG. 1A;

FIG. 9A is a flowchart illustrating one exemplary embodiment of a payload orientation optimization routine;

FIG. 9B is a flowchart illustrating another exemplary embodiment of a payload orientation optimization routine;

FIG. 10 is an illustration of an optimized orientation of two wind turbine blades of FIG. 7 according to an output of a payload orientation optimization routine based on a minimum clearance cost function;

FIG. 11 is an illustration of an optimized orientation of the two wind turbine blades of FIG. 7 and the interior cargo bay of FIG. 8B based on a maximum deviation cost function;

FIG. 12 is an illustration of an optimized orientation of two wind turbine blades and the interior cargo bay of FIG. 11 based on an output of a payload orientation optimization routine configured to determine a minimum cargo bay clearance cost function;

FIG. 13A is an illustration of the wind turbine blades of FIG. 7, showing 2D cross-sectional segments used for calculating an approximate 3D convex hull value of a non-optimized payload arrangement of the wind turbine blades;

FIG. 13B is an illustration of the exact 3D convex hull solution of the two wind turbine blades of FIG. 13A, showing the 2D cross-sectional segments used for calculating the approximate 3D convex hull value;

FIG. 13C is an illustration of the approximate 3D convex hull of FIG. 13B showing where the input wind turbine blade geometries intersect with the approximation;

FIG. 14A is an illustration of the wind turbine blades of FIG. 7, showing 2D cross-sectional segments used for calculating an approximate 3D convex hull value of an optimized payload arrangement of the wind turbine blades;

FIG. 14B is an illustration of the wind turbine blades of FIG. 7 arranged according to the optimized payload arrangement of FIG. 14A;

FIG. 14C is an illustration of the optimized payload arrangement of the wind turbine blades of FIG. 14B inside the interior cargo bay of the aircraft of FIG. 1; and

FIG. 15 is a block diagram of one exemplary embodiment of a computer system for use in conjunction with the present disclosures.

### DETAILED DESCRIPTION

Certain exemplary embodiments will now be described to provide an overall understanding of the principles of the structure, function, manufacture, and use of the devices, systems, aircraft, and methods disclosed herein. One or more examples of these embodiments are illustrated in the accompanying drawings. Those skilled in the art will understand that the devices, systems, aircraft, components related to or otherwise part of such devices, systems, and aircraft, and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Some of the embodiments provided for herein may be schematic drawings, including possibly some that are not labeled as such but will be understood by a person skilled in the art to be schematic in nature. They may not to be scale or may be somewhat crude renderings of the disclosed components. A person skilled in the art will understand how to implement these teachings and incorporate them into work systems, methods, aircraft, and components related to each of the same, provided for herein.

To the extent the present disclosure includes various terms for components and/or processes of the disclosed devices, systems, aircraft, methods, and the like, one skilled in the art, in view of the claims, present disclosure, and knowledge of the skilled person, will understand such terms are merely examples of such components and/or processes, and other components, designs, processes, and/or actions are possible. By way of non-limiting example, while the present application describes loading an airplane through a front end of the aircraft, alternatively, or additionally, loading can occur through an aft end of the aircraft and/or from above and/or below the aircraft. In the present disclosure, like-numbered and like-lettered components of various embodiments generally have similar features when those components are of a similar nature and/or serve a similar purpose. To the extent terms such as front, back, top, bottom, forward, aft, proximal, distal, etc. are used to describe a location of various components of the various disclosures, such usage is by no means limiting, and is often used for convenience when describing various possible configurations. The foregoing notwithstanding, a person skilled in the art will recognize the common vernacular used with respect to aircraft, such as the terms “forward” and “aft,” and will give terms of those nature their commonly understood meaning. Further in some instances, terms like forward and proximal or aft and distal may be used in a similar fashion.

The present application is directed to systems and methods for quickly and efficiently taking new irregular shapes (e.g., unknown shapes corresponding to future wind turbine blades, towers, industrial oil equipment, mining equipment, rockets, military equipment and vehicles, defense hardware, crane segments, aircraft components, space launch rocket boosters, helicopters, generators, hyperloop tubes, and many other pieces of oversized cargo) and determining optimized orientations for packaging the objects having the irregular shapes together to fit as much as possible into a fixed-size interior cargo bay of an existing air vehicle.

The present disclosure is also related to large, transport-category aircraft, capable of moving oversized cargo not traditionally shippable by air. For example, wind turbine blades are irregular in shape and new wind turbine blades are very long (e.g., exceeding 80 meters to 90 meters) to provide greater electrical power generating efficiency. The present disclosure provides systems and methods for analyzing the size and shape of multiple wind turbine blades to determine a packing strategy that can determine how to rotate and position the blades with respect to each other to improve packing density and yet maintain the wind turbine blades at safe minimum distances from each other to protect the blades from damage.

Still further, the present disclosure is related to designing interior cargo bay spaces to best adapt for the optimized packages, thus providing for optimized interior cargo bay space in addition to optimized payload packages.

Examples of the present disclosure can analyze multiple large, irregularly-shaped objects to determine how they may be oriented in space, subject to multiple constraints, to automatically optimize for multiple cost functions, such as to: (i) restrict predefined ranges of orientation; (ii) maintain a minimum clearance between objects in a payload; (iii) minimize an overall volume of the payload; (iv) minimize the distance from a payload to set of entities (e.g., orienting a payload as close as possible to a cargo centerline); and/or (v) maximize the distance from a payload to a set of entities (e.g., maintaining a minimum clearance between the payload and the cargo bay and centering that payload within that cargo bay).

### Example Cargo Aircraft for Carrying Large Irregularly-Shaped Objects

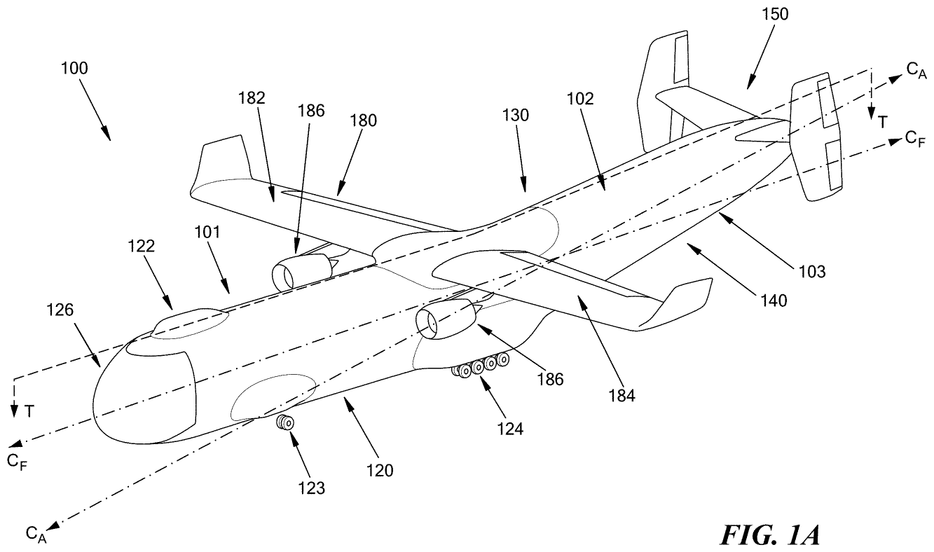

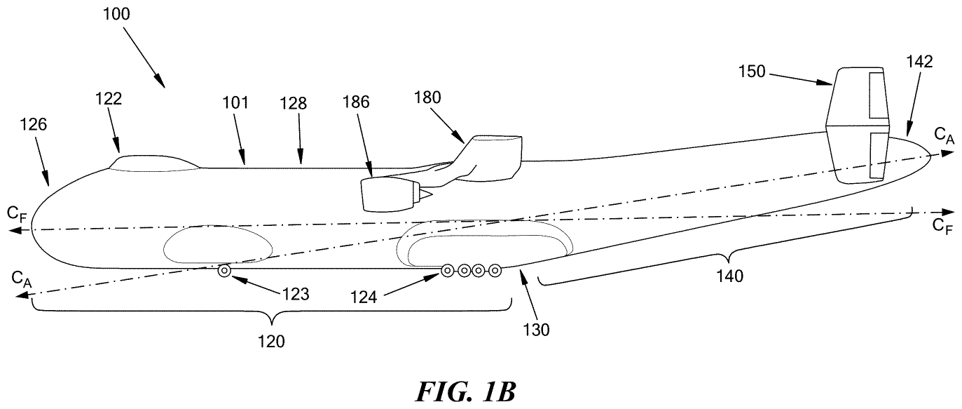

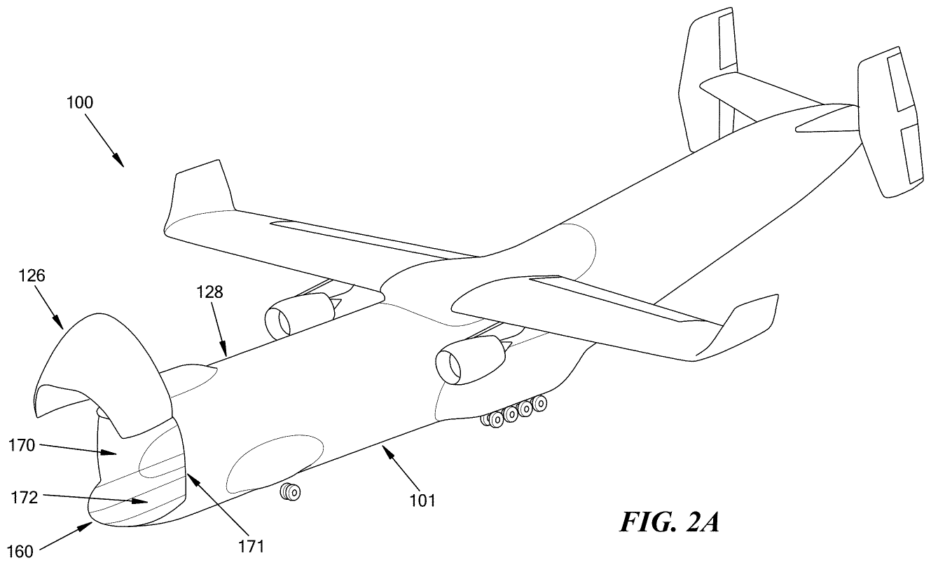

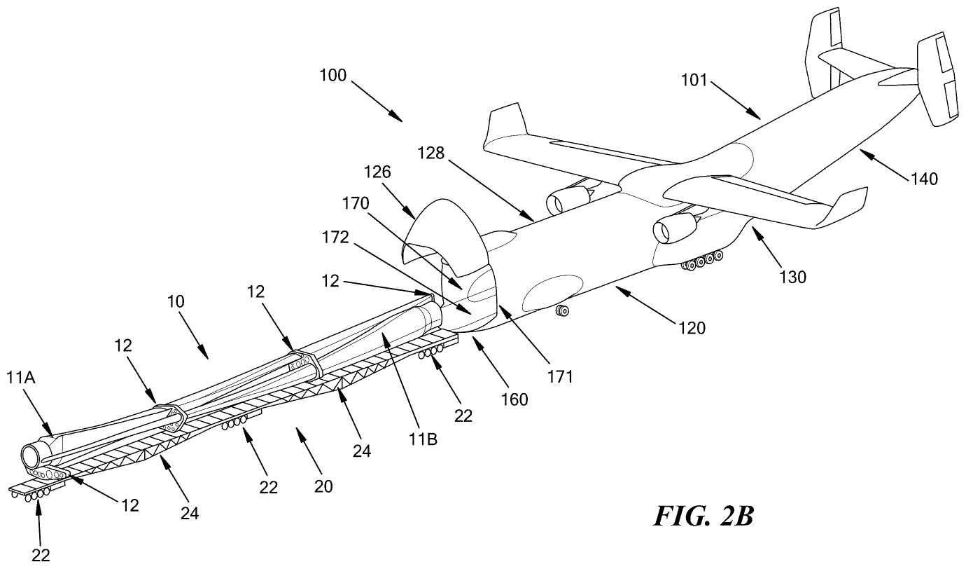

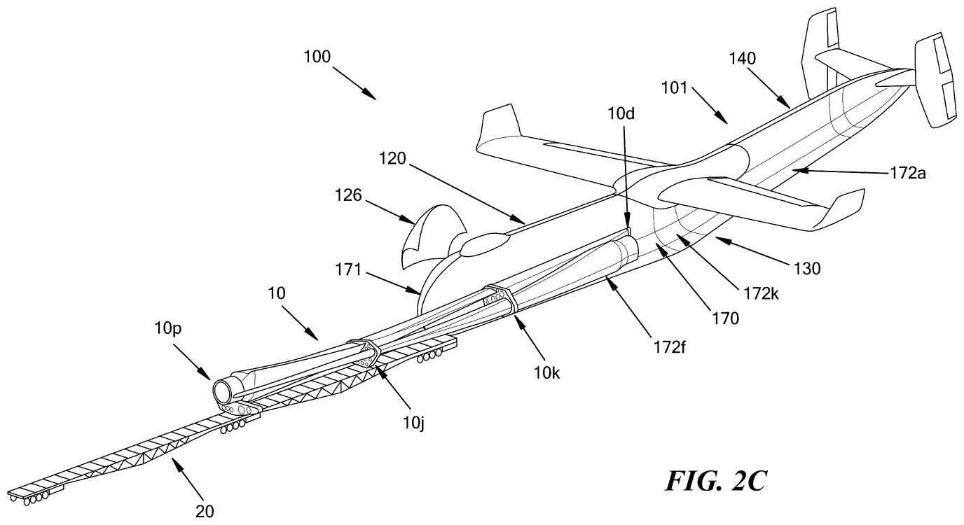

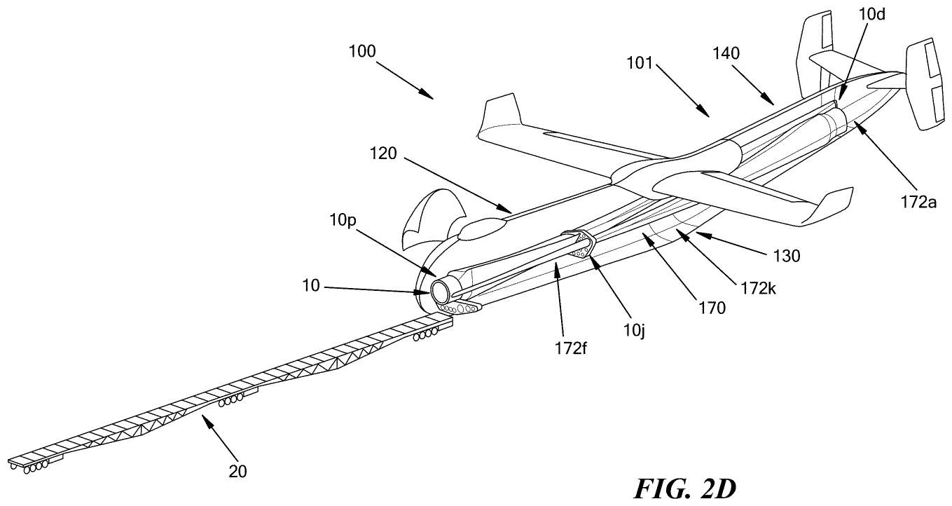

The focus of the present disclosures is described with respect to a large aircraft 100, such as an airplane, illustrated in FIGS. 1A and 1B, along with the loading of a large payload into the aircraft, illustrated at least in FIGS. 2A-2D. Additional details about the aircraft and payload may be described with respect to the other figures of the present disclosure as well. In the illustrated embodiment, a payload 10 is a combination of two wind turbine blades 11A and 11B (FIGS. 2B-2D), although a person skilled in the art will appreciate that other payloads are possible. Such payloads can include other numbers of wind turbine blades (e.g., one, three, four, five, etc., or segments of a single even larger blade), other components of wind turbines (e.g., tower segments, generator, nacelle, gear box, hub, power cables, etc.), or many other large structures and objects whether related to wind turbines or not. The present application can be used in conjunction with most any large payload—large for the present purposes being at least about 57 meters long, or at least about 60 meters long, or at least about 65 meters long, or at least about 75 meters long, or at least about 85 meters long, or at least about 90 meters long, or at least about 100 meters long, or at least about 110 meters long, or at least about 120 meters long—or for smaller payloads if desired. Some non-limiting examples of large payloads that can be used in conjunction with the present disclosures beyond wind turbines include but are not limited to industrial oil equipment, mining equipment, rockets, military equipment and vehicles, defense hardware, commercial aerospace vehicles, crane segments, aircraft components, space launch rocket boosters, helicopters, generators, or hyperloop tubes. In other words, the aircraft 100 can be used with most any size and shape payload, but has particular utility when it comes to large, often heavy, payloads.

As shown, for example in FIGS. 1A-1B and 2A-2D, the aircraft 100, and thus its fuselage 101, includes a forward end 120 and an aft end 140, with a kinked portion 130 connecting the forward end 120 to the aft end 140. The forward end 120 is generally considered any portion of the aircraft 100, and related components, that are forward of the kinked portion 130 and the aft end 140 is considered any portion of the aircraft 100, and related components, that are aft of the kinked portion 130. The kinked portion 130, as described in greater detail below, is a section of the aircraft 130 in which both a top-most outer surface 102 and a bottom-most outer surface 103 of the fuselage 101 become angled (notably, the placement of reference numerals 102 and 103 in the figures do not illustrate location of the “kink” since they more generally refer to the top-most and bottom-most surfaces of the fuselage 101), as illustrated by an aft centerline C_{A} of the aft end 140 of the fuselage 101 with respect to a forward centerline C_{F} of the forward end 120 of the fuselage 101.

The forward end 120 can include a cockpit or flight deck 122, and landing gears, as shown a forward or nose landing gear 123 and a rear or main landing gear 124. The illustrated embodiment does not show various components used to couple the landing gears 123, 124 to the fuselage 101, or operate the landing gears (e.g., actuators, braces, shafts, pins, trunnions, pistons, cylinders, braking assemblies, etc.), but a person skilled in the art will appreciate how the landing gears 123, 124 are so connected and operable in conjunction with the aircraft 100. The forward-most end of the forward end 120 includes a nose cone 126. As illustrated more clearly in FIG. 2A, the nose cone 126 is functional as a door, optionally being referred to the nose cone door, thus allowing access to an interior cargo bay 170 defined by the fuselage 101 via a cargo opening 171 exposed by moving the nose cone door 126 into an open or loading position (the position illustrated in FIG. 2A; FIGS. 1A and 1B illustrate the nose cone door 126 in a closed or transport position). The door may operate by rotating vertically tip-upwards about a lateral axis, or by rotating horizontally tip-outboards about a vertical axis, or by other means as well such as translation forwards then in other directions, or by paired rotation and translation, or other means.

As described in greater detail below, the interior cargo bay 170 is continuous throughout the length of the aircraft 101, i.e., it spans a majority of the length of the fuselage. The continuous length of the interior cargo bay 170 includes the space defined by the fuselage 101 in the forward end 120, the aft end 140, and the kinked portion 130 disposed therebetween, such spaces being considered corresponding to the forward bay, aft bay, and kinked bay portions of the interior cargo bay 170. The interior cargo bay 170 can thus include the volume defined by nose cone 126 when it is closed, as well as the volume defined proximate to a fuselage tail cone 142 located at the aft end 140. In the illustrated embodiment of FIG. 2A, the nose cone door 126 is hinged at a top such that it swings clockwise towards the fuselage cockpit 122 and a fixed portion or main section 128 of the fuselage 101. In other embodiments, a nose cone door can swing in other manners, such as being hinged on a left or right side to swing clockwise or counter-clockwise towards the fixed portion 128 of the fuselage. The fixed portion 128 of the forwards fuselage 101 is the portion that is not the nose cone 126, and thus the forwards fuselage 101 is a combination of the fixed portion 128 and the nose cone 126. Alternatively, or additionally, the interior cargo bay 170 can be accessed through other means of access known to those skilled in the art, including but not limited to a hatch, door, and/or ramp located in the aft end 140 of the fuselage 101, hoisting cargo into the interior cargo bay 170 from below, and/or lowering cargo into the interior cargo bay 170 from above. One advantage provided by the illustrated configuration, at least as it relates to some aspects of loading large payloads, is that by not including an aft door, the interior cargo bay 170 can be continuous, making it significantly easier to stow cargo in the aft end 140 all the way into the fuselage tail cone 142. While loading through an aft door is possible with the present disclosures, doing so would make loading into and use of the interior cargo bay 170 space in the aft end 140 all the way into the fuselage tail cone 142 much more challenging and difficult to accomplish—a limitation faced in existing cargo aircraft configurations. Existing large cargo aircraft are typically unable to add cargo in this way (e.g., upwards and aftwards) because any kink present in their aft fuselage is specifically to create more vertical space for an aft door to allow large cargo into the forwards portion of the aircraft.

A floor 172 can be located in the interior cargo bay 170, and can also extend in a continuous manner, much like the bay 170 itself, from the forward end 120, through the kinked portion 130, and into the aft end 140. The floor 172 can thus be configured to have a forward end 172f, a kinked portion 172k, and an aft end 172a. In some embodiments, the floor 172 can be configured in a manner akin to most floors of cargo bays known in the art. In some other embodiments, discussed in greater detail below, one or more rails can be disposed in the interior cargo bay 170 and can be used to assist in loading a payload, such as the payload 10, into the interior cargo bay 170 and/or used to help secure the location of a payload once it is desirably positioned within the interior cargo bay 170.

Opening the nose cone 126 not only exposes the cargo opening 171 and the floor 172, but it also provides access from an outside environment to a cantilevered tongue 160 that extends from or otherwise defines a forward-most portion of the fixed portion 128 of the fuselage 101. The cantilevered tongue can be an extension of the floor 172, or it can be its own feature that extends from below or above the floor 172 and associated bottom portion of the fuselage 101. The cantilevered tongue 160 can be used to support a payload, thus allowing the payload to extend into the volume of the interior cargo bay 170 defined by the nose cone 126.

A wingspan 180 can extend substantially laterally in both directions from the fuselage. The wingspan 180 includes both a first fixed wing 182 and a second fixed wing 184, the wings 182, 184 extending substantially perpendicular to the fuselage 101 in respective first and second directions which are approximately symmetric about a longitudinal-vertical plane away from the fuselage 101, and more particularly extending substantially perpendicular to the centerline C_{F}. Wings 182, 184 being indicated as extending from the fuselage 101 do not necessarily extend directly away from the fuselage 101, i.e., they do not have to be in direct contact with the fuselage 101. Further, the opposite directions the wings 182, 184 extend from each other can alternatively be described as the second wing 184 extending approximately symmetrically away from the first wing 182. As shown, the wings 182, 184 define approximately no sweep angle and no dihedral angle. In alternative embodiments, a sweep angle can be included in the tip-forwards (−) or tip-aftwards (+) direction, the angle being approximately in the range of about −40 degrees to about +60 degrees. In other alternative embodiments, a dihedral angle can be included in the tip-downwards (negative, or “anhedral”) or tip-upwards (positive, or “dihedral”) direction, the angle being approximately in the range of about −5 degrees to about +5 degrees. Other typical components of wings, including but not limited to slats for increasing lift, flaps for increasing lift and drag, ailerons for changing roll, spoilers for changing lift, drag, and roll, and winglets for decreasing drag can be provided, some of which a person skilled in the art will recognize are illustrated in the illustrations of the aircraft 100 (other parts of wings, or the aircraft 100 more generally, not specifically mentioned in this detailed description are also illustrated and recognizable by those skilled in the art). Engines, engine nacelles, and engine pylons 186 can also be provided. In the illustrated embodiment, two engines 186, one mounted to each wing 182, 184 are provided. Additional engines can be provided, such as four or six, and other locations for engines are possible, such as being mounted to the fuselage 101 rather than the wings 182, 184.

The kinked portion 130 provides for an upward transition between the forward end 120 and the aft end 140. The kinked portion 130 includes a kink, i.e., a bend, in the fixed portion 128 of the fuselage 101 such that both the top-most outer surface 102 and the bottom-most outer surface 103 of the fuselage 101 become angled with respect to the centerline C_{F} of the forward end 120 of the aircraft 100, i.e., both surfaces 102, 103 include the upward transition provided for by the kinked portion 130. As shown at least in FIG. 1B, the aft-most end of the aft end 140 can raise entirely above the centerline C_{F}. In the illustrated embodiment, the angle defined by the bottom-most outer surface 103 and the centerline C_{F} is larger than an angle defined by the top-most outer surface 102 and the centerline C_{F}, although other configurations may be possible. Notably, although the present disclosure generally describes the portions associated with the aft end 140 as being “aft,” in some instances they may be referred to as part of a “kinked portion” or the like because the entirety of the aft end 140 is angled as a result of the kinked portion 130. Thus, references herein, including in the claims, to a kinked portion, a kinked cargo bay or cargo bay portion, a kinked cargo centerline, etc. will be understood by a person skilled in the art, in view of the present disclosures, to be referring to the aft end 140 of the aircraft 100 (or the aft end in other aircraft embodiments) in some instances.

Despite the angled nature of the aft end 140, the aft end 140 is well-suited to receive cargo therein. In fact, the aircraft 100 is specifically designed in a manner that allows for the volume defined by the aft end 140, up to almost the very aft-most tip of the aft end 140, i.e., the fuselage tail cone 142, can be used to receive cargo as part of the continuous interior cargo bay 170. Proximate to the fuselage tail cone 142 can be an empennage 150, which can include horizontal stabilizers for providing longitudinal stability, elevators for controlling pitch, vertical stabilizers for providing lateral-directional stability, and rudders for controlling yaw, among other typical empennage components that may or may not be illustrated but would be recognized by a person skilled in the art.

The aircraft 100 is particularly well-suited for large payloads because of a variety of features, including its size. A length from the forward-most tip of the nose cone 126 to the aft-most tip of the fuselage tail cone 142 can be approximately in the range of about 60 meters to about 150 meters. Some non-limiting lengths of the aircraft 100 can include about 80 meters, about 84 meters, about 90 meters, about 95 meters, about 100 meters, about 105 meters, about 107 meters, about 110 meters, about 115 meters, or about 120 meters. Shorter and longer lengths are possible A volume of the interior cargo bay 170, inclusive of the volume defined by the nose cone 126 and the volume defined in the fuselage tail cone 142, both of which can be used to stow cargo, can be approximately in the range of about 1200 cubic meters to about 12,000 cubic meters, the volume being dependent at least on the length of the aircraft 100 and an approximate diameter of the fuselage (which can change across the length). One non-limiting volume of the interior cargo bay 170 can be about 6850 cubic meters. Not accounting for the very terminal ends of the interior cargo bay 170 where diameters get smaller at the terminal ends of the fuselage 101, diameters across the length of the fuselage, as measured from an interior thereof (thus defining the volume of the cargo bay) can be approximately in the range of about 4.3 meters to about 13 meters, or about 8 meters to 11 meters. One non-limiting diameter of the fuselage 101 proximate to its midpoint can be about 9 meters. The wingspan, from tip of the wing 132 to the tip of the wing 134, can be approximately in the range of about 60 meters to 110 meters, or about 70 meters to about 100 meters. One non-limiting length of the wingspan 180 can be about 80 meters. A person skilled in the art will recognize these sizes and dimensions are based on a variety of factors, including but not limited to the size and mass of the cargo to be transported, the various sizes and shapes of the components of the aircraft 100, and the intended use of the aircraft, and thus they are by no means limiting. Nevertheless, the large sizes that the present disclosure both provides the benefit of being able to transport large payloads, but faces challenges due, at least in part, to its size that make creating such a large aircraft challenging. The engineering involved is not merely making a plane larger. As a result, many innovations tied to the aircraft 100 provided for herein, and in other counterpart patent applications, are the result of very specific design solutions arrived at by way of engineering.

Materials typically used for making fuselages can be suitable for use in the present aircraft 100. These materials include, but are not limited to, metals and metal alloys (e.g., aluminum alloys), composites (e.g., carbon fiber-epoxy composites), and laminates (e.g., fiber-metallic laminates), among other materials, including combinations thereof.

FIGS. 2B-2D provide for a general, simplified illustration of one exemplary embodiment of loading a large payload 10 into the aircraft 100. As shown, the cargo nose door 126 is swung upwards into its open position, exposing the portion of the interior cargo bay 170 associated with the fixed portion 128 of the fuselage 101, which can extend through the kinked portion 130 and through essentially the entirety of the aft end 140. The cargo opening 171 provides access to the interior cargo bay 170, and the cantilevered tongue 160 can be used to help initially receive the payload. As shown, the payload 10 includes two wind turbine blades 11A, 11B, held with respect to each other by payload-receiving fixtures 12. The payload-receiving fixtures 12 are generally considered part of the payload, although in an alternative interpretation, the payload 10 can just be configured to be the blades 11A, 11B. This payload 10 can be considered irregular in that the shape, size, and weight distribution across the length of the payload is complex, causing a center of gravity of the payload to be at a separate location than a geometric centroid of the payload. One dimension (length) greatly exceeds the others (width and height), the shape varies with complex curvature nearly everywhere, and the relative fragility of the payload requires a minimum clearance be maintained at all times as well as fixturing support the length of the cargo at several locations even under the payload's own weight under gravity. Additional irregular payload criteria can include objects with profiles normal to a lengthwise axis rotate at different stations along that axis, resulting in a lengthwise twist (e.g., wind turbine blade spanwise twist) or profiles are located along a curved (rather than linear) path (e.g., wind turbine blade in-plane sweep). Additionally, irregular payloads include objects where a width, depth, or height vary non-monotonically along the length of the payload (e.g., wind turbine blade thickness can be maximal at the max chord station, potentially tapering to a smaller cylinder at the hub and to a thin tip). The term irregular package will be similarly understood.

The payload 10, which can also be referred to as a package, particularly when multiple objects (e.g., more than one blade, a blade(s) and ballast(s)) are involved, possibly secured together and manipulated as a single unit, can be delivered to the aircraft 100 using most any suitable devices, systems, vehicles, or methods for transporting a large payload on the ground. A package can involve a single object though. In the illustrated embodiment, a transport vehicle 20 includes a plurality of wheeled mobile transporters 22 linked together by a plurality of spans, as shown trusses 24. In some instances, one or more of the wheeled mobile transporters 22 can be self-propelled, or the transport vehicle 20 more generally can be powered by itself in some fashion. Alternatively, or additionally, an outside mechanism can be used to move the vehicle 20, such as a large vehicle to push or pull the vehicle 20, or various mechanical systems that can be used to move large payloads, such as various combinations of winches, pulleys, cables, cranes, and/or power drive units.

As shown in FIG. 2B, the transport vehicle 20 can be driven or otherwise moved to the forward end 120 of the aircraft 100, proximate to the cargo opening 171. Subsequently, the payload 10 can begin to be moved from the transport vehicle 20 and into the interior cargo bay 170. This can likewise be done using various combinations of one or more winches, pulleys, cables, cranes, and/or power drive units, such set-ups and configurations being known to those skilled in the art. FIG. 2C illustrates a snapshot of the loading process with half of the fuselage removed for illustrative purposes (as currently shown, the half of the nose cone 126 illustrated is in both an open and closed position, but during loading through the cargo opening 171, it is in an open position). As shown, the payload 10 is partially disposed in the interior cargo bay 170 and is partially still supported by the transport vehicle 20. A distal end 10d of the payload 10 is still disposed in the forward end 120, as it has not yet reached the kinked portion 130.

The system and/or methods used to move the payload 10 into the partially loaded position illustrated in FIG. 2C can continue to be employed to move the payload 10 into the fully loaded position illustrated in FIG. 2D. As shown, the distal end 10d of the payload 10d is disposed in the interior cargo bay 170 at the aft end 140, a proximal end 10p of the payload 10 is disposed in the interior cargo bay 170 at the forward end 120 (for example, on the cantilevered tongue 160, although the tongue is not easily visible in FIG. 2D), and the intermediate portion of the payload 10 disposed between the proximal and distal ends 10p, 10d extends from the forward end 120, through the kinked portion 130, and into the aft end 140. As shown, the only contact points with a floor of the interior cargo bay 170 (which for these purposes includes the tongue 160) are at the proximal and distal ends 10p, 10d of the payload 10 and at two intermediate points 10j, 10k between the proximal and distal ends 10p, 10d, each of which is supported by a corresponding fixture 12. In other embodiments, there may be fewer or more contact points, depending, at least in part, on the size and shape of each of the payload and related packaging, the size and shape of the cargo bay, the number of payload-receiving fixture used, and other factors. This illustrated configuration of the payload disposed in the interior cargo bay 170 is more clearly understood by discussing the configuration of the kinked fuselage (i.e., the fuselage 101 including the kinked portion 130) in greater detail. Once the payload 10 is fully disposed in the interior cargo bay 170, it can be secured within the cargo bay 170 using techniques provided for herein, in counterpart applications, or otherwise known to those skilled in the art.

Kinked Fuselage

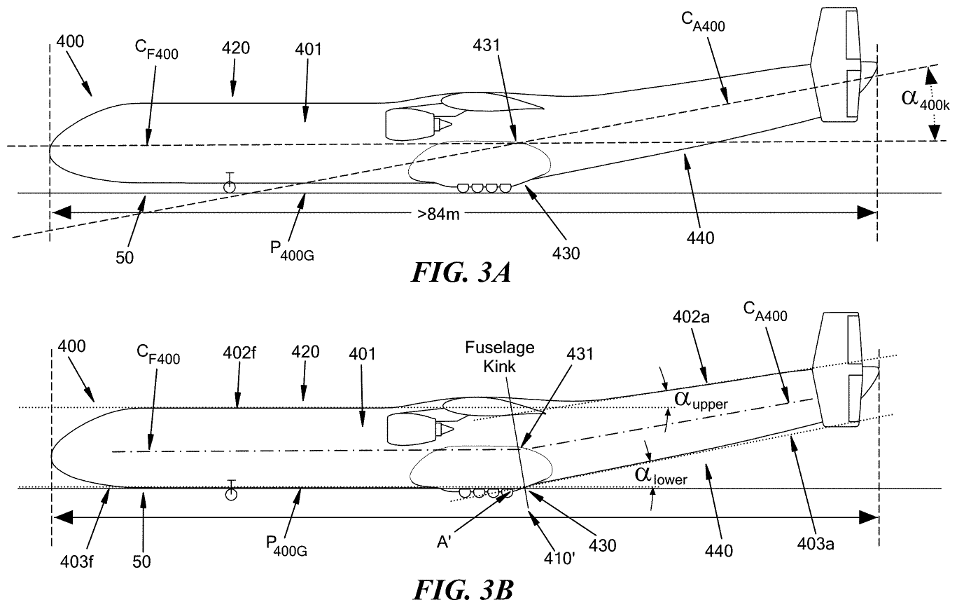

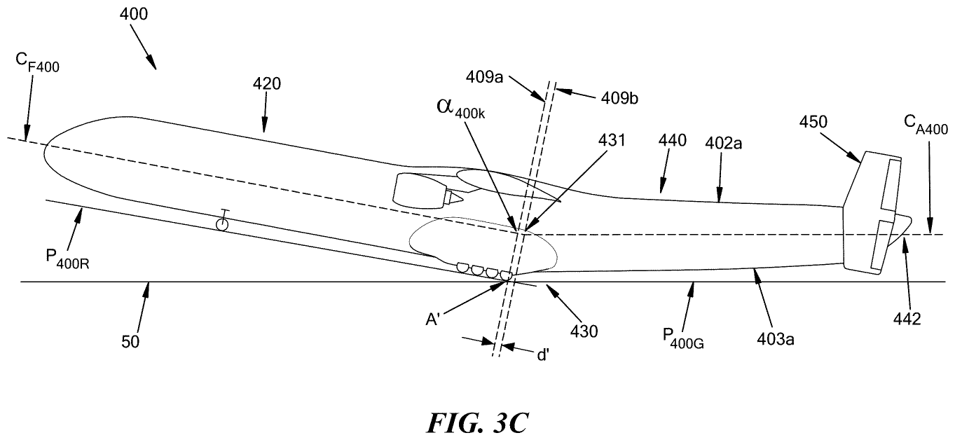

FIG. 3A is a side view illustration of an exemplary cargo aircraft 400 of the present disclosure. The aircraft 400, which is shown to be over 84 meters long, includes a fuselage 401 having a forward end 420 defining a forward centerline C_{F400} and an aft end 440 defining an aft centerline C_{A400}, with the aft centerline C_{A400} being angled up with respect to the forward centerline C_{F400}. The forward and aft centerlines C_{F400}, C_{A400} define a junction or kink 431 therebetween, where the forward centerline C_{F400} angles upward as the overall aft fuselage, which is in the aft end 440, changes in direction to be angled with respect to the forward fuselage, which is in the forward end 420. This defines a kink angle α₄₀₀ₖ of the aft fuselage 440. The kink location 431 is contained in the kinked portion 430 disposed between and connecting the forward and aft ends 420, 440. FIG. 3B shows the forward centerline C_{F400} as being an approximate midpoint between a top-most outer or upper surface 402f and a bottom-most outer or lower surface 403f of the fuselage 401 forward of a lateral axis of rotation A′, with the aft centerline C_{A400} being an approximate midpoint between an upper surface 402a and a lower surface 403a of the fuselage 401 aft of the lateral axis of rotation. FIG. 3B shows the kink 431 between the forward centerline C_{F400} and the aft centerline C_{A400} as being an approximate change in the angle of a plane 410′ substantially perpendicular to the centerline C_{F400} and most of the upper and lower surfaces 402a, 403a extending aft from the kink 431, such that the fuselage 401 aft of the kink 431 has a substantial portion of an approximately constant height or cross-sectional area. This represents only one example, and in other instances the upper surface 402a does not necessarily extend approximately parallel to the lower surface 402b at all even if the aft fuselage still defines a kink 431 in the centerline.

In FIG. 3B, the angle of the aft centerline C_{A400} with respect to the forward centerline C_{F400} defines a kink or bend angle (illustrated as α_{400K} in FIG. 3A), which can be approximately equal to average of an angle αᵤₚₚₑᵣ of the after upper surface e 402a and an angle wow, of the lower surface 403a with respect to the forward centerline C_{F400} and forward upper and lower surfaces 402f, 403f for the case of a constant cross-section forward fuselage 401, as shown in FIG. 3B (hence, FIG. 3B indicating the upper and lower surfaces 402a, 403a defining the respective upper and lower angles αᵤₚₚₑᵣ, α_{lower}). In some instances, the angles αᵤₚₚₑᵣ, α_{lower} of the aft upper and lower surfaces 402a, 403a vary with respect to the angle of the aft centerline C_{A400}, with the location of a substantial upward deflection in the overall centerline (e.g., kink 431) being defined by the overall shape and slope of the aft fuselage with respect to the forward fuselage (or more generally the overall shape and slope of the aft end 440 with respect to the forward end 420). For example, for the aircraft 100 of FIG. 1B, the lower surface defines a lower angle α_{lower}, which is approximately equal to the tailstrike angle of approximately 12 degrees, and the upper surface angle αᵤₚₚₑᵣ in the aft fuselage is approximately between 6 and 7 degrees. In some exemplary embodiments, the result kink angle of the aft centerline C_{A400} can be approximately in the range of about 0.5 degrees to about 25 degrees, and in some instance it is about 10 degrees with respect to a longitudinal—lateral plane of the cargo aircraft 100, i.e., a plane in which the forward centerline C_{F400} is disposed, the plane extend substantially parallel to the ground or a ground plane P_{400G}. Further, the kink angle α_{400K} can be approximately equal to a degree of maximal rotation of the aircraft during the takeoff operation. Still further, a length of the aft end 140, i.e., the portion that is angled with respect to the forward centerline C_{F400}, can be approximately in the range of about 15% to 65%, and in some instances about 35% to about 50% of a length of the entire fuselage 101, and in some embodiments it can be about 49% the length of the fuselage 101.

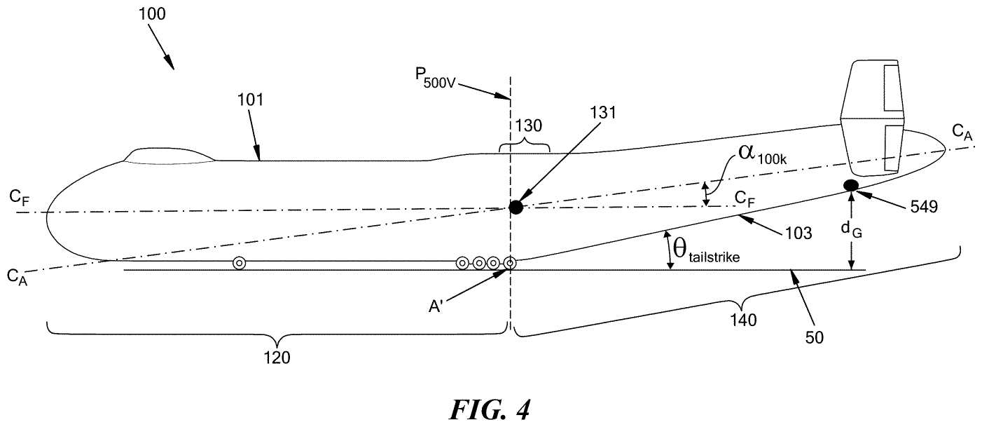

In FIG. 3C, the cargo aircraft 400 is shown on the ground 50 and rotated about the lateral axis of rotation to illustrate, for example, a takeoff pitch-up maneuver. In FIG. 3C, a resting plane P_{400R} of the forward end 420 angled with respect to the ground or ground plane P_{400G} at a degree just before θₜₐᵢₗₛₜᵣᵢₖₑ, as no part of the aft end 440, empennage 450, or tail 442 is contacting the ground. In this position, the lower surface 403a (and, approximately, the aft centerline C_{A400}) is substantially parallel with the ground or ground plane P_{400G}, and it can be seen that because the location of the centerline kink 431 of the kinked portion 430 is approximately with, or very close to, the lateral axis of rotation A′, the angle α_{400K} of the kink 431 is approximately the maximum safe angle of rotation of the aircraft 400 about the lateral axis of rotation A′. FIG. 3C shows a vertical axis 409a aligned with the location of the lateral axis of rotation A′ and another vertical axis 409b aligned with the kink 431 in the fuselage centerline C_{F400}, with a distance d′ therebetween. With d′ being small, and the lower surface 403a of the aft end 440 extending aft with approximately the kink angle α_{400K} of the kink 431 or a slightly larger angle, as shown, the aft end 440 is highly elongated without risking a tail strike. Accordingly, minimizing d′ approximately sets the lower angle α_{lower} as an upper limit to the safe angle of rotation about the lateral pitch axis. Moreover, the upward sweep of the upper surface 402a can be arranged to maintain a relatively large cross-sectional area along most of the aft end 440, thereby enabling a substantial increase in the overall length of the cargo aircraft 400, and thus usable interior cargo bay within the aft end 440, without increasing θₜₐᵢₗₛₜᵣᵢₖₑ. FIG. 4A shows this in further detail for the cargo aircraft 100 of FIG. 1A.

In FIG. 4, the aft centerline C_{A} and forward centerline C_{F} of the fuselage 101 are shown intersecting at a kink location 131 just aft of the vertical plane P_{500V} of the lateral axis of rotation A′, which occurs within the kinked portion 130 connecting the forward end or fuselage 120 to the aft end or fuselage 140. The lower surface 103 of the aft fuselage 140 approximately defines θₜₐᵢₗₛₜᵣᵢₖₑ of the cargo aircraft 100, which is slightly larger than a kink angle α_{100K} defined by the upslope of the aft centerline C_{A} with respect to the forward centerline C_{F}. Additionally, in some examples, the aft fuselage can include a sensor 549 configured to measure the distance d_{G} of the lower surface 103 of the aft fuselage 140 to the ground 50 to assist the pilot and/or computer in control of the aircraft 100 in maximally rotating the aircraft 100 about the lateral pitch axis without tailstrike.

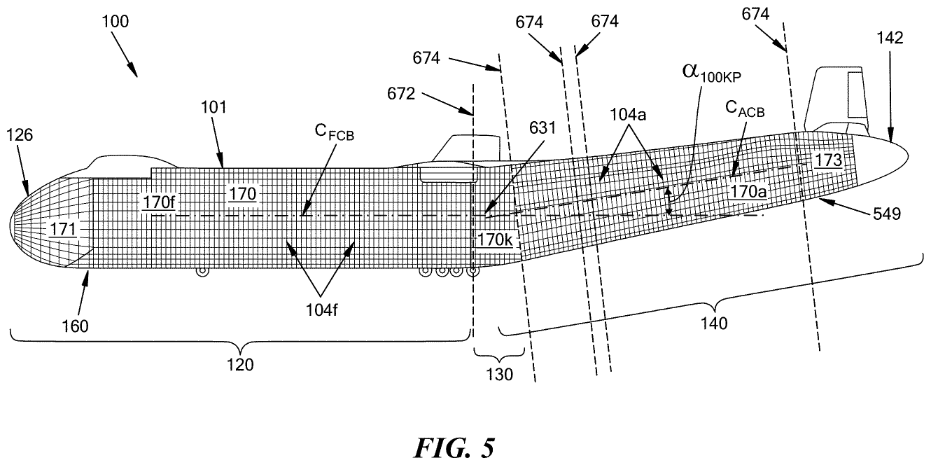

FIG. 5 is side cross-section view of the cargo aircraft 100, the cross-section being taken along an approximate midline T-T of the top-most outer surface, as shown in FIG. 1A. The cargo bay 170 defines a centerline that extends along the overall length of the cargo bay 170. The cargo bay 170 extends from a forward end 171 of a forward end or region 170f of the cargo bay 170, as shown located in the nose cone 126, to an aft end 173 of an aft end or region 170a of the cargo bay 170, as shown located in the fuselage tail cone 142. The forward and aft regions 170f, 170a of the cargo bay 170 sit within the forward and aft ends 120, 140, respectively, of the aircraft 100. More particularly, the forward region 170f can generally define a forward cargo centerline C_{FCB} that can be substantially colinear or parallel to the forward fuselage centerline C_{F} (shown in FIG. 4) and the aft region 170a can generally define an aft cargo centerline C_{ACB} that can be substantially colinear or parallel to the aft fuselage centerline C_{A} (shown in FIG. 4). Accordingly, in the kinked portion 130 of the fuselage 101, which itself can include a comparable kinked portion 170k of the cargo bay 170, where the aft fuselage centerline C_{A} bends with respect to the forward fuselage centerline C_{F}, the aft cargo centerline C_{ACB} also bends at a kink location 631 with respect to the forward cargo centerline C_{FCB}. The bend can be at approximately the same angle, as shown an angle α_{100KP}, as the kink angle α_{100K} of the fuselage 101. The aft cargo centerline C_{ACB} can extend at least approximately 25% of a length of a centerline of the continuous interior cargo bay 170, i.e., the length of the centerline throughout the entire cargo bay 170. This amount more generally can be approximately in the range of about 25% to about 50%. There are other ways to describe these dimensional relationships as well, including, by way of non-limiting example, a length of the aft cargo centerline C_{ACB} being at least approximately 45% of the length of the fuselage 101 and/or at least approximately 80% of a length of the fuselage 101 aft of the lateral pitch axis, among other relationships provided for herein or otherwise derivable from the present disclosures.

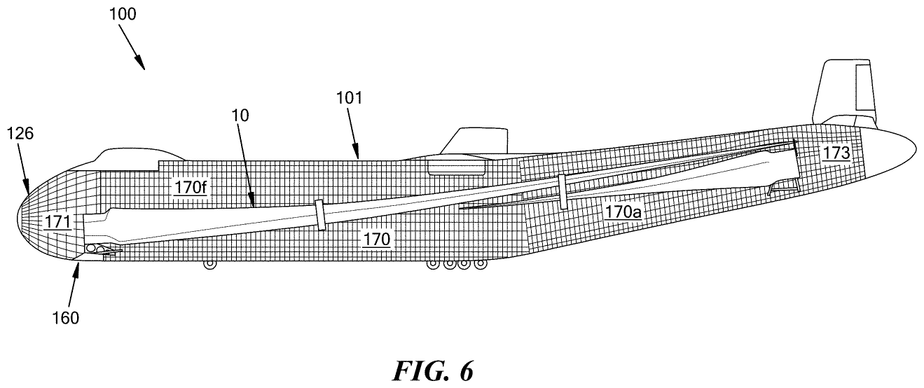

FIG. 5 shows the aft region 170a of the cargo bay 170 extending through almost all of the aft fuselage 140, which is a distinct advantage of the configurations discussed herein. Moreover, due to the length of the aft fuselage 140, a pitch 674 of structural frames 104a of the aft fuselage 140 can be angled with respect to a pitch 672 of structural frames 104f of the forward fuselage 120 approximately equal to the kink angle α_{100K} of the fuselage 101. In some examples, the kinked region 130 represents an upward transition between the pitch 672 of the structural frames 104f of the forward fuselage 120 and the pitch 674 of the structural frames 104a of the aft fuselage 140. A person skilled in the art will recognize that structural frames 104a, 104f are merely one example of structural features or elements that can be incorporated into the fuselage 101 to provide support. Such elements can be more generally described as circumferentially-disposed structural elements that are oriented orthogonally along the aft centerline C_{ACB} and the forward centerline C_{FCB}. In some examples, the location of the cargo bay kink 631 (FIG. 5) is forward or aft of the fuselage kink 131 (FIG. 4) such that either the forward cargo region 170f partially extends into the aft fuselage 140 or the aft cargo region 170a partially extends into the forward fuselage 120, however, this generally depends, at least in part, on the distance between the interior of the cargo bay 170 and the exterior of the fuselage, which is typically a small distance for cargo aircraft having a maximally sized cargo bay. Regardless, to fully utilize examples of the present disclosure, the aft region 170a of the cargo bay 170 can be both (1) able to be substantially extended due to the ability of the aft fuselage 140 length to be extended and (2) able to extend along substantially all of the length of the aft fuselage 140 because examples of the present disclosure enable aircraft to have elongated aft fuselages for a fixed tailstrike angle and/or minimized kink angle. Additionally, minimizing the fuselage kink angle for elongated aft fuselages allows the aft region of the cargo bay to extend further along the fuse fuselage while increasing the maximum straight-line payload length for a given overall aircraft length and tailstrike angle, as shown at least in FIG. 6.

FIG. 6 shows a side cross-sectional view of the fuselage 101 of the cargo aircraft 100 of FIG. 5 with a highly elongated payload 10 of two wind turbine blades 11A, 11B disposed substantially throughout the interior cargo bay 170 and extending from the forward end 171 of the forward region 170f to the aft end 173 of the aft region 170a. Having at least a portion of the aft region 170a being linearly connected to (e.g., within line of sight) of at least a portion of the forward region 170f enables the extension of the aft region 170a to result in an extension in the maximum overall length of a rigid payload capable of being carried inside the interior cargo bay 170. Wind turbine blades, however, are often able to be deflected slightly during transport and so examples of the present disclosure are especially suited to their transport as the ability to slightly deflect the payload 10 during transport enables even long maximum payload lengths to be achieved by further extending the aft end 173 of the aft region 170a beyond the line of sight of the forward-most end 171 of the forward region 170f.

Additional details about a kinked fuselage configuration may be provided in a counterpart patent application entitled “AIRCRAFT FUSELAGE CONFIGURATIONS FOR AVOIDING TAIL STRIKE WHILE ALLOWING LONG PAYLOADS,” filed concurrently herewith, the content of which is incorporated by reference herein in its entirety.

Payload Optimization Systems and Methods

Examples of the present disclosure include systems and methods of calculating optimized orientations of multi-object cargo payloads to maximize their packing efficiency. Examples include routines for determining one or more optimized payload configurations implemented using a computer processor executing a software program that takes, as an input, two or more objects (e.g., wind turbine blades) each having a 3D surface geometry (or one is calculated from a plurality of parameters defining the input object) that includes a large number of tessellated arbitrary surfaces. The program can then execute one or more optimization routines that sequentially perturb the orientation and position of each 3D surface geometry through a large number of possible positions with respect to each other (and, in some instances, a cargo bay volume). The program can further, for each position, calculate one or more cost functions and, as an output, return those orientations of each object for which the calculated cost functions are one or more of minimized, maximized, within some predetermined threshold, and/or satisfies a similar type(s) of constraint.

In an exemplary embodiment, conventional software can be used to create the tessellated 3D surface geometry for each object and, when applicable, for the interior of the cargo bay, which can be made up entirely of triangles or other arbitrary planar polygons. In another alternative embodiment, custom-written software can be used to create the same tessellated 3D surface geometry for each object and, when applicable, for the interior of the cargo bay, which can be made up entirely of triangles or other arbitrary planar polygons A finer tessellation process requires more triangles to define the surface, but also can result in a 3D surface geometry that more closely approximates the actual surface of the object being modeled. Accordingly, the fineness or resolution of the tessellation can depend on, for example, a parameter or cost function of the payload being calculated. For instance, if the cost function being calculated is a minimum clearance between each object of more than six (6) inches, it may be advantageous to have a 3D surface geometry that can vary less than a maximum of one (1) inch from the surface of the real object such that the maximum possible variance between 3D surface geometries objects is four (4) inches on the corresponding real objects.

In operation, determining an optimal orientation of one or more elongated irregular objects in space, such as wind turbine blades, can require numerous perturbations of each object in space and an evaluation of each minimum distance between the objects for clearance, as well as an evaluation of additional cost functions, such as volume or payload cargo bay clearance.

It may be desirable to reduce analysis time by using coarser tessellation with fewer triangles, but with the appreciation that the coarser tessellation provides less accurate representations of the actual nominal curved surface. In one embodiment, a goal may be to tessellate the surfaces to achieve an accuracy of the representation of the object within a distance of 10% of the desired minimum clearance between the blades. This implies that the worst-case error introduced into the clearance would be less than 20% of the desired minimum clearance. However, statistically it is highly unlikely that the points of nearest approach on each different object will occur where the maximum deviation between the tessellated surface and the actual nominal curved surface occurs. Given that the vertices of each tessellation triangle are projected to the actual nominal surface exactly, the error due to the deviation between the tessellated triangle representation and the actual nominal curved surface may be estimated by analyzing the distance between the actual nominal curved surface and the centroid of the representative triangle.

Those skilled in the art will appreciate that regions of higher curvature on the wind turbine blade typically require more tessellation triangles than flat regions of the blade. Those skilled in the art will further appreciate that one can arbitrarily select the degree of accuracy by generating a more/less accurate surface representation by increasing/decreasing the number of tessellation triangles.

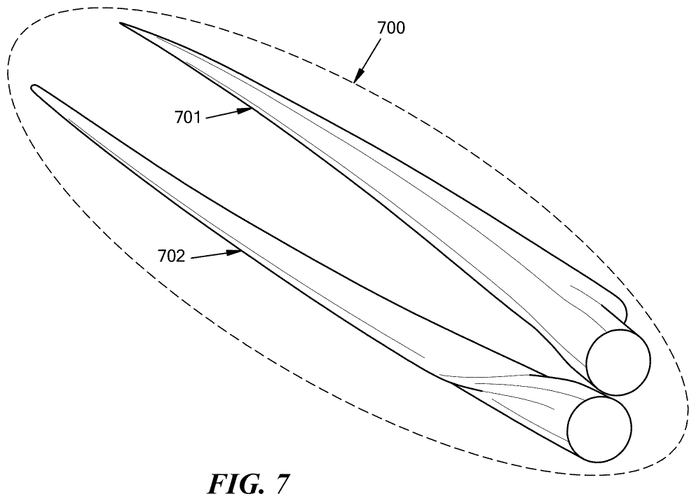

FIG. 7 shows an example of two very irregular objects in an arbitrary orientation that can subsequently have their orientations optimized using aspects of the present disclosure to determine a packaging arrangement of the two objects that can satisfy one or more cost functions, in addition to a simple clearance constraint (e.g., they are not contacting or inside of each other). Specially, FIG. 7 shows two wind turbine blades 701, 702 defining a payload arrangement 700, with each blade 701, 702 being about 100 m long and occupying about 538.15 meters³ of volume, for a sum of 1,076.31 meters³ of occupied space of the blade combination. However, this payload arrangement 700 of wind turbine blades 701, 702 cannot nest perfectly together as illustrated because of their awkward, complex, irregular shapes. Moreover, there is no orientation or position of one wind turbine blade relative to the other that results in zero gap distances between one another over significant portions of their surfaces. Therefore, to package these wind turbine blades 701, 702 together and transport them as a cargo payload 700, they will require much more total volume to hold the package than the sum of the enclosed volume of each individual blade.

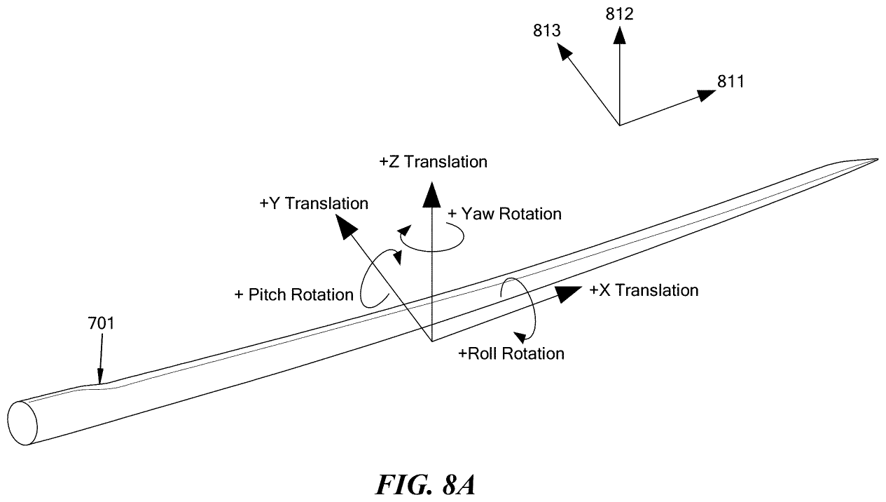

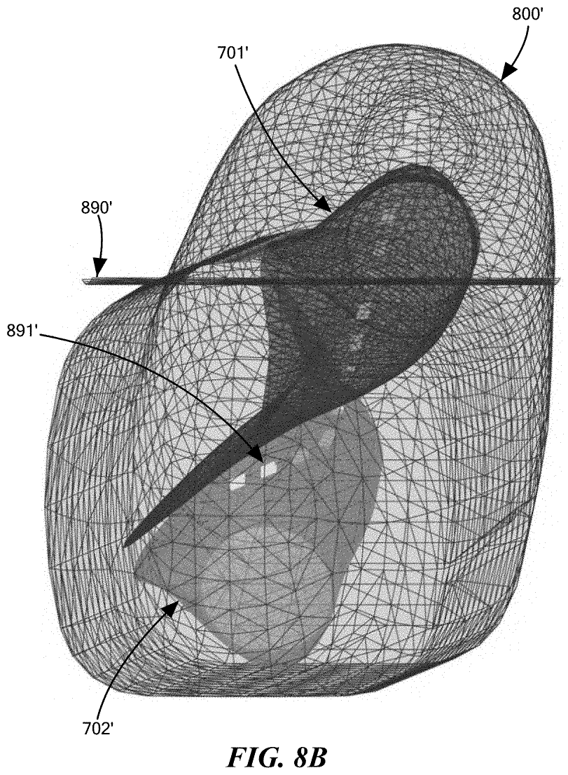

The output of the optimization routine is one or more orientations, with the degrees of freedom of the orientation of each object being shown in FIG. 8A for a wind turbine blade 701, with each of the six degrees of freedom being: Roll (also referred to herein as ‘dRoll’), which is as angle of rotation about an X axis 811, Pitch (also referred to herein as ‘dPitch’), which is an angle of rotation about a Y axis 813, Yaw (also referred to herein as ‘dYaw’), which is an angle about Z axis 812), Position along the X axis 811 (also referred to herein as variable ‘dX’), Position along the Y axis 813 (also referred to herein as ‘dY’), and Position along the Z axis 812 (also referred to herein as ‘dZ’), each of which can be varied for each object being positioned and orientated during the optimization routine. For each change in one of the six degrees of freedom for each object, the clearance is checked and, if necessary, one or more cost functions are also checked. After each orientation of each object has been checked, the output can be a plot that shows contours of cost functions versus orientation variables. In some situations, the absolute global minimum solution for a cost function is not necessarily the best choice for the final orientation of the payload. However, the process described herein makes it simple to select another configuration with marginally worse cost function magnitude but which is a better overall choice for other reasons. In some instances, the range of each variable of one or more objects can be constrained by one or more parameters, such as a maximum cargo bay dimension (e.g., no object is translated to a position more than a difference between the overall length of the longest object and the cargo bay, as, for example, arranging two 100 meter objects in a 110 meter long cargo bay requires that the other object not be translated along the axes closest approximating the 100 meter length by more than 10 meters or so). Additionally, during the optimization, each degree of freedom can be incremented at a certain fineness or coarseness, which can determine the overall level of computation required. As such, it is also possible to optimize the optimization routine by running it multiple times, for example, using a first coarse increment to find a few orientations that satisfy the cost functions, and then re-running the routine with finer increments but with a range of the positions and orientation variables being roughly constrained about the known solution regions to further determine the presence of local minimum and better optimize any global minimum. Alternatively, it is possible to automate such an approach using an adaptive algorithm which adds additional sub-increments to each degree of freedom of each object near the locations of the coarsely evaluated degree of freedom increments which yielded the best cost function values.

FIG. 8B shows an example of the tessellated objects 701′, 702′ corresponding to the wind turbine blades 701, 702 of FIG. 7 arranged in a tessellated cargo volume 800′ representing an aircraft cargo bay. FIG. 8B can represent, for example, a snapshot of the optimization routine where a given orientation of each of the tessellated objects 701′, 702′ is being considered with respect to the tessellated cargo volume 800′, with minimum clearances being calculated and any additional cost functions, as explained in more detail below.

The data generated by examples of the processes described herein allow for quick and compact modeling of the resulting orientations in CAD space with only six (6) numbers (e.g., the degrees of freedom variables). In some examples, for processing more than two wind turbine blades, it is possible to initiate the process by optimizing the orientation for two blades together, then optimize the third blade against the “pre-packaged” pair of blades already optimized. For four wind turbine blades, it is also possible to model the two pairs separately and then optimize the pre-packaged pairs with respect to each other. This is merely one option in the optimization process. It is possible to model an arbitrary number of blades individually rather than pre-packaged pairs. Those skilled in the art will appreciate that N=6 variables are used for two blades, N=12 for three blades, N=18 for four blades, and so forth. With a high-performance computing cluster, it is possible run parallel processing sweeps through all orientations to determine the optimal packaging.

In general, examples of the process disclosed herein can take an arbitrary number of tessellated arbitrary surfaces and execute a routine to output minimized cost function orientations, where the cost functions can include, but are not limited to: (i) resultant payload volume (e.g., the volume of the convex hull of a combination of the objections); (ii) unsigned distance from a set of entities (e.g., a cloud of points, a series of line or curve segments, an additional arbitrary discrete or analytical surface); and/or (iii) signed distance relative to a set of entities (e.g., a cloud of points, a series of line or curve segments, an additional arbitrary discrete or analytical surface). One or more of these cost functions may be minimized within additional constraints, such as, for example, maintaining a minimum spatial clearance between each arbitrary surface in the optimized package or restrictions on allowable orientation of each arbitrary surface in the optimized package.

Examples of the present disclosure can therefore be used to analyze multiple large, irregularly-shaped objects to determine how they may be optimally oriented in space and/or in a predefined cargo bay volume, and optimally subject to multiple constraints, to automatically optimize for multiple cost functions, such as to: (i) restrict predefined ranges of orientation; (ii) maintain a minimum clearance between objects in a payload; (iii) minimize an overall volume of the payload; (iv) minimize the distance from the payload to a set of entities (e.g. orienting a payload as close as possible to a cargo centerline); and/or (v) maximize the distance from the payload to a set of entities (e.g., maintaining a minimum clearance between the payload and the cargo bay, or centering the payload within the cargo bay).

Examples include reducing the overall computational time of an optimization process by restricting the ranges of orientations or the objects. For example, it is not necessary to consider object orientations where the longest dimension of one object is orthogonal to the longest dimension of another object, as this orientation will obviously be unable to result in the optimal cost function of minimizing the overall payload volume. Similarly, there are situations in which object symmetry implies that certain orientations do not need to be analyzed because they are non-unique. Finally, there may be manufacturer restrictions on certain object orientations during transportation, making it unnecessary to evaluate prohibited orientations.

In addition to optimizing the packaging of one or more objects, the process can evaluate orientations within the limitations of the internal volume of the available cargo space (e.g., in the cargo bay of an aircraft). For example, a cargo bay may have “Keep Out” spaces where the payload is not allowed to intrude. In one embodiment, the process described herein can minimize the maximum distance from a curve along the cargo bay centerline to the furthest point outwards on the cargo. In another embodiment, the process described herein can maximize the minimum distance from aircraft structures in the cargo bay to the nearest point on the outside of the payload package to maintain as much clearance as possible.

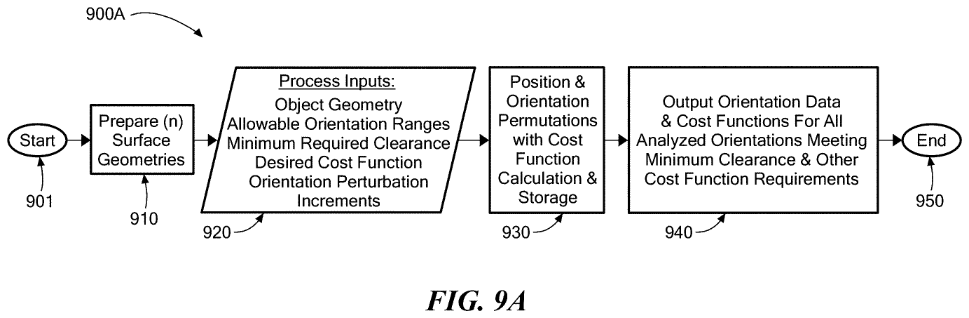

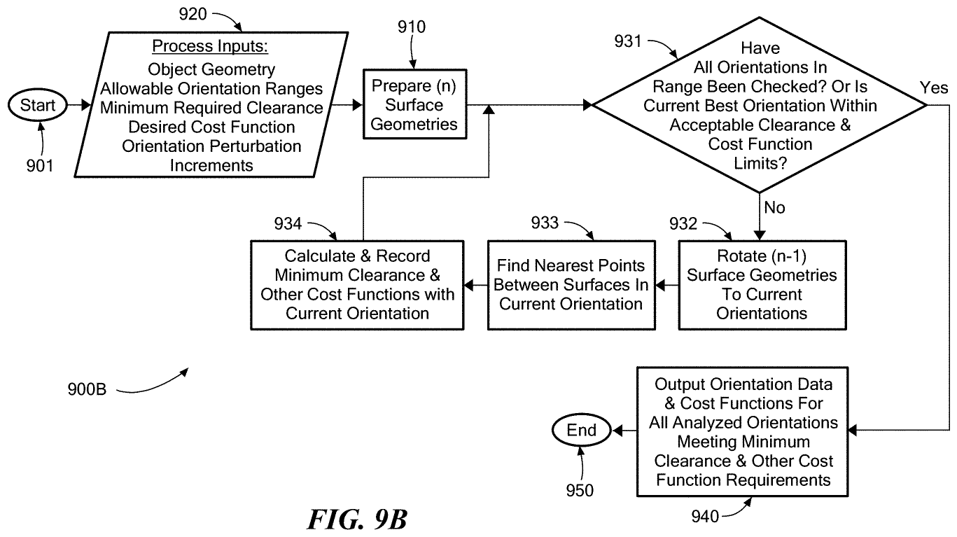

Examples of the systems and methods follow the processes illustrated in the flowcharts of FIGS. 9A and 9B. The example process 900A of FIG. 9A can start (step 901) by creating (step 910) geometric inputs (e.g., 3D surface geometries) for each object to be optimized as a payload. In the example process 900A this tessellation can occur as an initial step, and may be outside of the optimizing routine, for example, using existing software solutions that may be external to the processes discussed herein. Additionally, step 910 can include taking existing 3D surface geometries and adjusting or changing their properties, such as tessellation density, to better execute the subsequent optimization steps. The example process 900A continues with an input receiving (step 920) parameters for use during the optimization routine, for example one or more allowable ranges of orientation for each object, minimum required clearance, additional desired cost functions, and/or increment size in perturbations of the objects. In some instances, the example process 900A allows for preparation or modification of each 3D surface geometry during or after this step (as shown in the example process 900B of FIG. 9B), such that the subject optimization calculations can be processed more efficiently or quickly because the 3D surface geometry may be simplified without significantly impacting the accuracy of the process beyond a fraction of the minimum required clearance.

The example process 900A proceeds to an optimization routine (step 930) in which the process can perturb each combination of every object through the full range of permitted orientations by the input increments in translation along each spatial axis, and in rotation about each spatial axis. At each unique orientation, the minimum distance between each unique object can be checked against the minimum required clearance between all objects, and other cost functions can be computed (e.g., total packaged volume dimensions or convex hull volume, maximum unsigned distance from entities including a series of points, curves, surfaces, and/or volumes inside of a cargo bay, and/or minimum signed distance from entities including a series of points, curves, surfaces, and/or volumes defining the structural edges of a cargo bay). After the full range of orientations are analyzed, the process continues by outputting (step 940) each orientation that meets clearance and/or cost function constraints, along with cost function output, to allow selection from output of the optimum blade packaging (minimum cost function), or alternatively, a solution that is close to optimum but may meet additional constraints. The outputting can include storing the cost functions and/or calculated clearances for each individually calculated orientation, or, in some instances, storing each of the orientations and their corresponding cost functions for orientations that satisfy one or more constraints on the cost functions or clearance. Implementations of this brute-force optimization approach to evaluating the entire orientation space can be extremely thorough (e.g., robust at finding global minimums to within the tolerance of the perturbation increments) and parallel (e.g., allowing fully independent evaluation of each orientation in isolation).

The example process 900B of FIG. 9B illustrates an optimization routine (e.g., step 930 of FIG. 9A) in more internal detail. In the example process 900B, the optimization routine (step 930 of FIG. 9A) includes a series of steps defining each iteration in a single loop. The optimization routine includes a checker (step 931) to see if all orientations have been considered and/or if some desired optimized orientation has been achieved and, if so, proceed to the output 940. The check can call an incrementer (step 932) to adjust the position of one or more of the 3D surface geometries, and afterwards a geometric processor (step 933) can determine one or more points on the 3D surface geometries according to the cost functions (e.g., determining the closest two point between to objects). The result(s) can be sent to a comparer (step 934) to calculate cost function values and cross-check any cost function constraints with the values.

An example variation of these processed 900A, 900B includes a more complex solver approach that determines sensitivities in each cost functions by perturbing the object orientations to determine a local minimum in cost function at far fewer evaluated orientations.

Optimization Routine

It is difficult to show the plurality of nested loop of the optimization routine (e.g., step 930 of FIG. 9A) in a single flowchart, as there are six (6) variables to sweep through for each blade that is being oriented or positioned relative to another blade and/or cargo bay shape. Accordingly, a pseudocode example is presented below for a two-object optimization loop (i.e., ‘Blade1’ and ‘Blade2’), with each layer representing a nested loop adjusting one of the degrees of freedom a respective blade for each of the six degrees of freedom—dRoll (angle about X axis in degrees), dPitch (angle about Y axis in degrees), dYaw (angle about Z axis in degrees), dX (position along X axis in inches), dY (position along Y axis in inches), and dZ (position along Z axis in inches)—which are varied. There can be a minimum and maximum value checked for each degree of freedom. For the angles, one example can include a full range that would be the bounds from spherical coordinates (e.g., dRoll, dYaw each being incremented from −180 deg to +180 deg, and dRoll from −90 deg to +90 deg), however, examples can include reductions in these bounds being applied due to common sense, for example, that the pitch angle range will not exceed 50% above and below a fuselage kink angle. For the lengths, a full range example would roughly the difference in length between the primary dimensions of the blades and the cargo bay, in each direction: for a 100 meter blade in a 105 meter fuselage, the blades may be taken forward and aft by five (5) meters from an intermediate position to cover the full range.

Below is a pseudocode example the structure of an optimization routine (e.g., step 930 of FIG. 9A) for two blades within a fixed cargo bay boundary, with each loop being an individual layer forming a series of nested lops, and each loops incrementing one degree of freedom for one object (e.g., Bade1) by a single step (e.g., DRolllncrement), where each loop increments the degree of freedom (e.g., dRoll) through a range (e.g., MinDRoll to MaxDRoll):

```
For Blade1DRoll From MinDRoll To MaxDRoll By DRollIncrement:
  For Blade1DYaw From MinDYaw To MaxDYaw By DYawIncrement:
    For Blade1DPitch From MinDPitch To MaxDPitch By DPitchIncrement:
      For Blade1DX From MinDX To MaxDX By DXIncrement:
        For Blade1DY From MinDY To MaxDY By DYawIncrement:
          For Blade1DZ From MinDZ To MaxDZ By DZIncrement:
            TRANSLATE & ROTATE BLADE1 TO CURRENT POSITION & ORIENTATION
            For Blade2DRoll From MinDRoll To MaxDRoll By DRollIncrement:
              For Blade2DYaw From MinDYaw To MaxDYaw By DYawIncrement:
                For Blade2DPitch From MinDPitch To MaxDPitch By DPitchIncrement:
                  For Blade2DX From MinDX To MaxDX By DXIncrement:
                    For Blade2DY From MinDY To MaxDY By DYawIncrement:
                      For Blade2DZ From MinDZ To MaxDZ By DZIncrement:
                        TRANSLATE & ROTATE BLADE1 TO CURRENT
                        POSITION & ORIENTATION
                        CALCULATE COST FUNCTIONS
                        STORE RESULT AND ORIENTATION IN
                        AN N-DIMENSIONAL ARRAY
                      Next Blade2DZ
                    Next Blade2DY
                  Next Blade2DX
                Next Blade2DPitch
              Next Blade2DYaw
            Next Blade2DRoll
          Next Blade1DZ
        Next Blade1DY
      Next Blade1DX
    Next Blade1DPitch
  Next Blade1DYaw
Next Blade1Droll
```

The above routines can result in a substantial number of orientations to be calculated. For example, if the number of calculations for each degree of freedom is ten (10), the result is 10⁶ total permutations. Accordingly, it can be advantageous to limit the ranges of each degree of freedom and use larger increments. Additionally, in examples that include conducting a “packaging” step and a “place/orient payload in vehicle” step separately, during the packaging step the one object can be held static during an optimization routine. Then, once the best “payload package” of the objects relative to one another has been determined, a single 6-DOF sweep of a resultant packaged payload within the cargo bay with additional cost functions described above can be performed. In algorithm parlance, this is replacing to get a lower number of permutations:

10¹² to optimize 3 blades+10⁶ to orient and position final blade package, which is substantially less than 10¹⁸ to simultaneously package blades together and orient the blades in the cargo payload in a single optimization algorithm.

3D Surface Geometries

The meshes that are used in this problem are inputs, and examples of these are as follows:

One spatially 3D, topologically 2D surface mesh (also referred to as a triangulation, tessellation or discretization of the surface) for each object in the payload package.

One spatially 3D, topologically 1D curve mesh (also referred to as a line-segment curve) for the cargo bay centerline.

One spatially 3D, topologically 2D surface mesh for the cargo bay zone boundary. This boundary may include walls, structural members, and/or any other geometries that the payload package must not touch, clash, or otherwise interfere with in physical 3D space.

The meshing process 910 can be simply used to get a simple, small, easily manipulated representation of these 3D surface geometries. The meshing process 910 itself can be just preparation for the software code (e.g., Pointwise). The 3D surface geometries, or meshes, can be triangulations of the object surfaces. This is also called tessellation or discretization and can also be done using fully triangular meshes or quadrilaterals or more general polygons (which can optionally be subdivided into triangles when first read in). FIG. 8B is an example of triangulated blade meshes for two blades 701′, 702′, a fuselage cargo bay 800′, and wing box 890′, and one point-distribution mesh 891′ along a centerline. The computational cost to calculate cost functions for these meshes can be directly proportional to the number of triangles. For example, checking clearance between blade 1 (mesh 701′ of N triangles) and blade 2 (mesh 702′ of M unique triangles), the distance between every triangle and every other triangle should be checked (e.g., NxM subroutine calls). As shown, each blade includes approximately 2000 triangles and the cargo bay boundary is about 4000 triangles, with about 25 line segments for the centerline. However, typically the less triangles used, the more inaccurate the representations of the surfaces become. Accordingly, examples can use a flat triangle approximation to a curved surface due to the deviation generally being near to the center of the triangle, giving an acceptable level of error when the inputs and results are kept within context. Alternate embodiments include using a higher-order representation of the meshes, such as splines rather than a line-segment curve or curved triangular cells in the surface meshes rather than planar faceted bodies.

The following sections describe different cost functions that can be calculated at each orientation. The first, a minimum clearance between the objects, ensures, at a minimum, that the objects in each orientation are not contacting each other (or are disposed inside each other), as which would not represent a valid position.

Minimum Clearance

Calculating the minimum clearance between each object ensures that a minimum amount of clearance can be maintained so that the objects do not damage or touch one another in the finished packaging. During air transport, for example, objects may undergo moderate vertical accelerations (e.g., approximately in the range of about −1.0G to about +2.5G) and often continuous vibration. While example objects like wind turbine blades are flexible items, and will deform small distances with loads, if they touch one another, they may abrade or forcefully collide in a way that leaves permanent, undesirable damage. By calculating a merit function of clearance, a filter may be applied to maintain a minimum amount of clearance, such as 6 inches between 100-meter-long wind turbine blades.

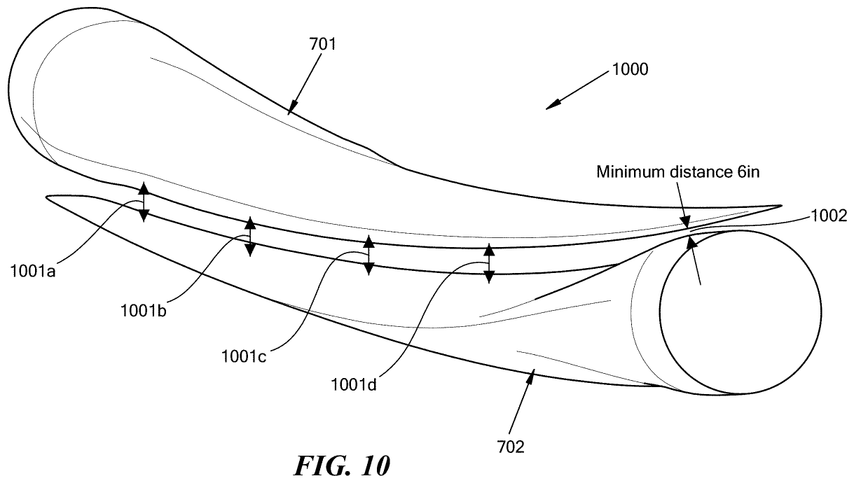

FIG. 10 is an illustration of the minimum clearance maintained by filtering all permutations of six degrees of freedom between one blade 701 while a second blade 702 is held static. In each orientation a large number of individual inter-object clearances 1001a-d are calculated to determine a minimum 1002.

Maximum Distance Between Payload and Cargo Bay Centerline

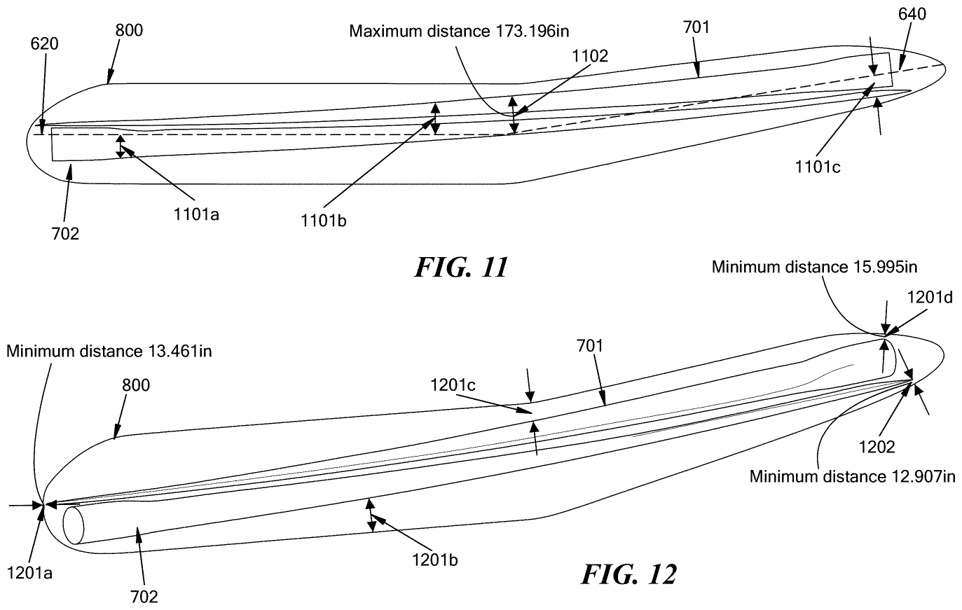

Calculating a maximum distance between a payload and a cargo bay centerline includes finding a value equal to the furthest distance that a position and orientation of a payload package can deviate from a cargo bay centerline such that the payload package may be pulled towards the centerline as closely as possible into the cargo bay. For example, if a position and orientation of cargo is found such that the distances between a payload and a cargo bay centerline is minimized, this means that the payload is as close overall as it can be for its shape to the vehicle centerline. FIG. 11 shows an example of the minimum solution for maximum distance between payload (comprising the first and second blades 701, 702) and cargo bay centerline 620, 640 of a cargo bay volume 800, which includes calculating many distances 1101a-d. The first and second blades 701, 702 (e.g., the payload) can be centered in the middle of the cargo bay 800 by reducing the maximum distance 1102 it strays from the cargo bay centerline 620, 640. If the first and second blades 701, 702 pitch or translate vertically, and/or yaws or translates horizontally, this maximum distance 1102 between the first and second blades 701, 702 and the cargo bay centerline 1102 will no longer be minimized as the payload package gets further than, for the example of FIG. 11, 173.2 inches from the cargo bay centerline. This cost function can be particularly useful when a cargo bay geometry is not yet known in preliminary design stages, but it does not account for centering a payload package in a cargo bay in the directions tangential to the cargo bay centerline.

Minimum Distance Between Payload and Cargo Bay Surface Geometry

Calculating a minimum distance between a payload and cargo bay surface geometry includes finding that a value equal to the closest distance between surfaces of a payload package and the surfaces of the edges of the surrounding cargo bay such that the payload package may be pushed away from the cargo bay walls as far as possible to center it within the cargo bay. For example, if the position and orientation of the cargo is found such that the distances between a payload and the cargo bay walls are maximized, it means the payload can be as far away from all walls simultaneously as it can be for its shape and the cargo bay wall geometry. FIG. 12 illustrates an example with the first and second blades 701, 702 and cargo bay 800 as previously shown in FIG. 11, but with the first and second blades 701, 702 oriented and positioned differently than before to center the first and second blades 701, 702 relative to the cargo bay 800 walls and balance out the location to achieve the highest global minimum distance 1202 between the payload and the cargo bay boundaries of 12.907 inches. With a known cargo bay 800 boundary, this cost function includes calculating a plurality of distances 1201a-d between the first and second blades 701, 702 and the cargo bay 800 walls to find the global minimum distance 1202.

Convex Hull Volume

Another example cost function to be calculated is a Convex Hull Volume Ratio (CHVR), which is a novel measure used here to estimate packing volume waste. CHVR is defined as a ratio between the volume of a convex hull of one or more objects divided by the sum of the volumes of the one or more objects. Accordingly, for a collection of perfectly packaged objects CHVR is 1, which is the definition of a 0% wasted volume. In poorly packaged objects, where a package is wasting as much volume unnecessarily as the individual objects themselves need, CHVR would be 2, which is 100% wasted volume.

A convex hull is the smallest volume that can enclose a set of one or more objects while maintaining the constraint that Gaussian curvature is globally greater than or equal to zero. Positive curvature corresponds with convexity and negative with concavity. Physically, this corresponds to the volume of a convex shell going around a group of objects with a flat (zero curvature) surface. As an illustrative example is, neglecting surface tension and viscosity, all surfaces of a convex hull will not hold water in nonzero gravity. A sphere or any other regular polyhedral is a convex hull, as is any single-direction stretched or single-direction-sheared version of them. A torus is not.

This is relevant when there is a desire to pack objects in as small a volume as possible, so one can imagine that the volume of a convex hull of two packaged wind turbine blades as being a measure of how efficiently they use the available volume. If the ratio of the convex hull volume to the sum of the enclosed volumes of the individual, potentially concave objects equals one, no volume has been wasted in packaging the items together.

Aspects of the present disclosure include efficiently estimating a 3D convex hull volume by integrating the product of the 2D convex hull areas of a set of cross-sections and the distance between the cross-sections, as explained in more detail below.

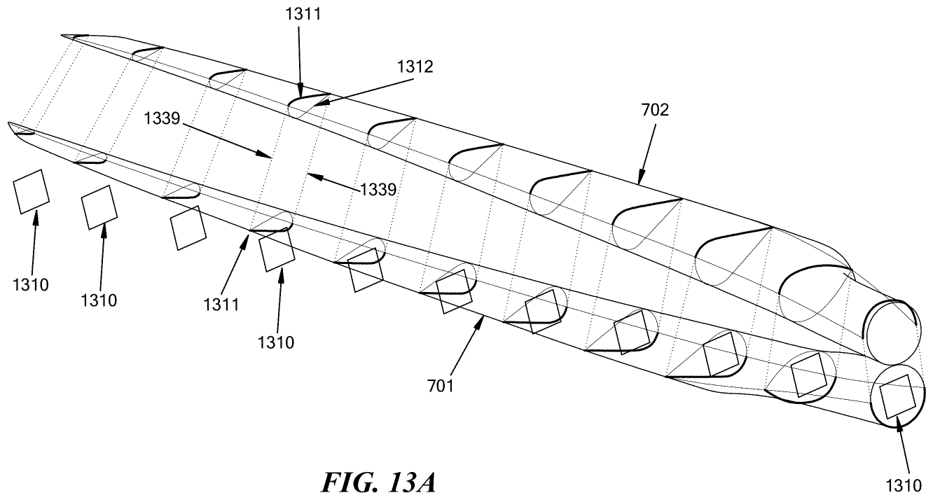

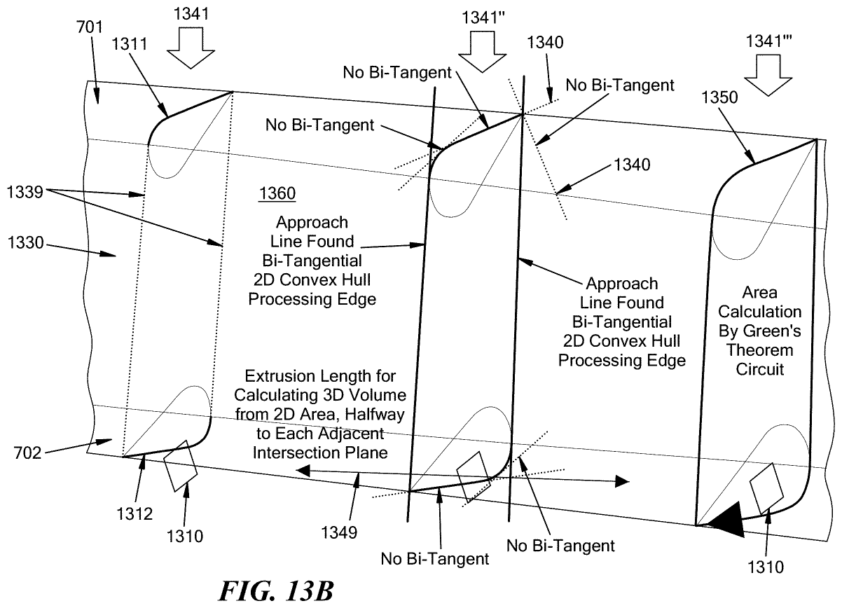

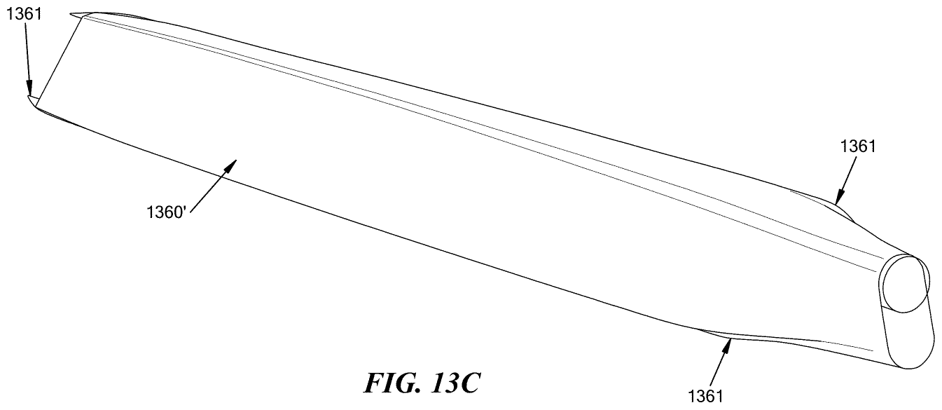

FIG. 13A is an example of two very unwieldy objects (e.g., first and second blades 701, 702) in an arbitrary orientation. Each blade 701, 702 is 100 meters long and occupies about 538.15 meters³ of volume, for a sum of 1,076.31 meters³ of occupied space of the blade combination. However, these first and second blades 701, 702 cannot nest perfectly together because of their awkward, complex, irregular shapes. There is no orientation or position of one blade relative to the other that results in zero gap distances between one another. Therefore, to package the first and second blades 701, 702 together and transport them as cargo, they will require more total volume to hold the package than the sum of the enclosed volume of each individual blade.

Rather than constructing a 3D convex hull by using bi-tangential planes in point locations of the 3D geometries, a fast, efficient, and reasonably accurate estimate of the convex hull volume is determined by taking periodic intersections of all objects along the longest dimension of the first blade 701, and constructing a 2D convex hull in the intersection plane 1310 using bi-tangential lines in point locations of the 2D intersections, then calculating the 2D area inside of the 2D convex hull, and multiplying it by the sum of half the distances to each neighboring intersection plane.

FIG. 13A is a graphical representation of a convex hull being built from all of the first and second blades 701, 702, from the 2D intersections taken along the length of the first blade 701. Each intersection plane 1310 crosses through the first and second blades 701, 702 to define intersection sections 1312, convex hull processing edges 1339, and retained section portions of sections 1311. There are only eleven (11) intersection planes 1310 shown here, with the accuracy of the estimate increasing with more intersections.

FIG. 13B is an illustration of each 2D convex hull section 1350 being built using approaching lines 1340 from all directions to find the bi-tangential connections 1339 to build a 2D convex hull processing edge 1331 upon, and the extrusion distance 1349. The area under the final line-segment curves can be calculated by proceeding in a circuit around the 2D convex hull shape and integrating the area using Green's theorem. Thereafter, a 3D convex hull volume 1360 can be assumed by connecting each 2D convex hull shape along the length, integrating the product of the individual 2D convex hull areas times the distances to locations halfway between them and adjacent locations. Note that the only curvature neglected by this 2D approach is the curvature occurring along the sectioning direction (orthogonal to the intersection planes), which is a reasonable, small and acceptable sacrifice in accuracy for the large increase in efficiency.

FIG. 13C shows a graphical representation of the 3D convex hull shape 1360 created in FIG. 13B, shown against parent objects (e.g., first and second blades 701, 702), with only small sections 1361 of the first and second blades 701, 702 extending beyond the approximated 3D convex hull 1360. Here, the 3D convex hull volume 1360 has an enclosed volume of 3,013.6 meters³. This implies that the CHVR=(3,013.6/1,076.31)−1≈(2.8)−1=180% wasted volume relative to the minimum volume occupied by the combination of the individual first and second blades 701, 702. This is an example of a very poor packaging arrangement of the first and second blades 701, 702.

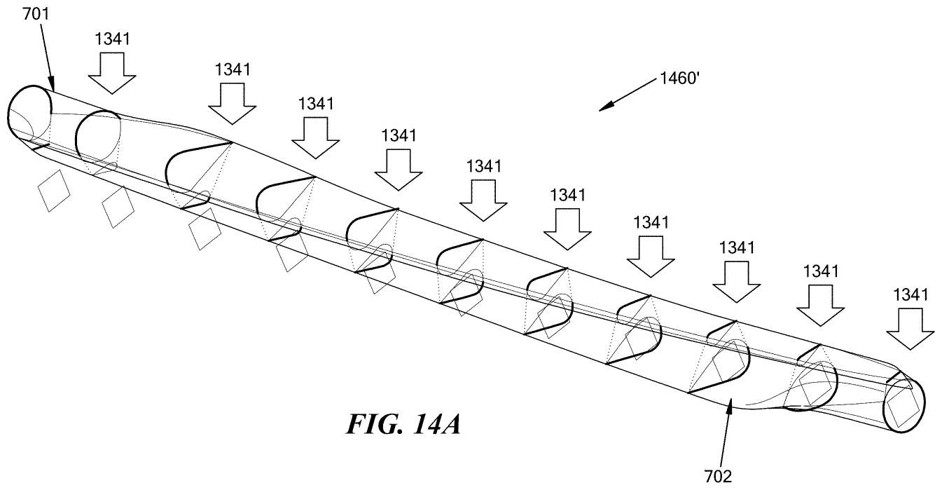

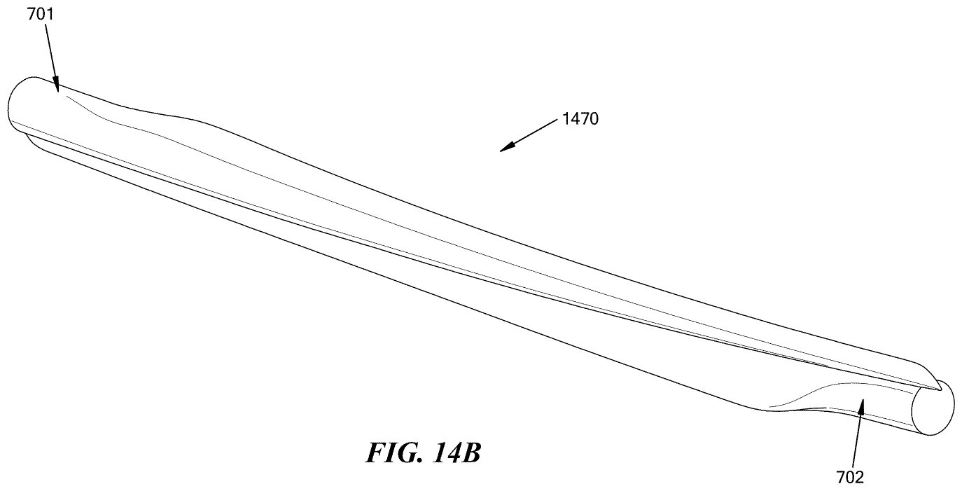

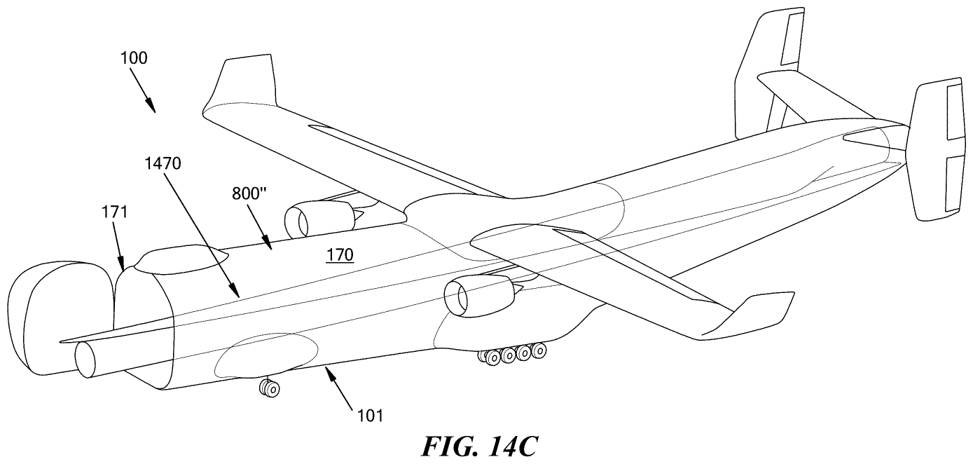

However, using aspects of the present optimization method, including sweeping through six degrees of freedom for each object and repeating the process, testing each combination of the orientations of the two blades, a number of optimized arrangements can be found where the wasted volume is substantially lower than 180%. As shown, for example, in FIG. 14B, where an optimized arrangement of the first and second blades 701, 702 is illustrated with a much more efficient packaging. Accordingly, less volume is wasted and the CHVR is lower. To achieve this orientation, the top blade 701 was rotated +176.5 degrees in the roll axis (about its longest dimension from root to tip). Here, a 3D convex hull calculated using the plurality of 2D planes 1341 has an enclosed volume of 1,530.7 meters³, giving a CHVR=(1,520.7/1,076.31)−1=42% wasted volume relative to the minimum volume occupied by the combination of the individual first and second blades 701, 702. This is a much better arrangement since the current 42% of wasted volume is much lower than the previous 180% of wasted volume. FIG. 14B shows the first and second blades 701, 702 in this optimized orientation as an optimized payload 1470.

Loading/Unloading Clearance

Additional more complicated cost functions are possible, such as calculating a minimum distance clearance between payload and cargo bay during a loading or unloading operation, to, for example, account for additional space and resulting reduction in minimum distance due to loading and unloading the cargo along a defined path. Implementations include adding a simulation step where the movement of the payload is captured in and out of the interior cargo bay. FIG. 14C shows the payload 1470 of FIG. 14B disposed in the interior cargo bay 170 of the aircraft 100 of FIG. 1A. Here, an example cost function includes the payload 1470 being moved into and/or out of the cargo bay 170 via the opening 171, while calculating the minimum clearances. With this result, it is possible to determine better package positions and orientations, which may sacrifice small amounts of clearance to the fuselage 101 (in the static positions discussed above) to gain larger amounts of clearance to the fuselage while the payload 1470 is in motion during loading and unloading.

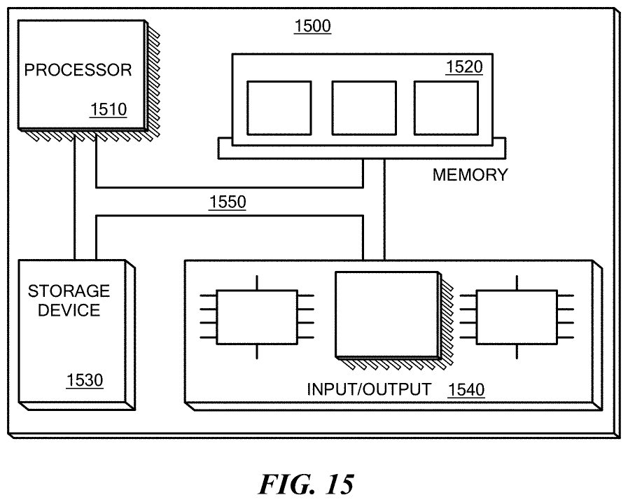

FIG. 15 is a block diagram of one exemplary embodiment of a computer system 1500 upon which the present disclosures can be built, performed, trained, etc. For example, referring to FIGS. 7 to 14C, any modules or systems can be examples of the system 1500 described herein, for example the optimization routines 900A, 900B and any of the associated modules or routines described therein. The system 1500 can include a processor 1510, a memory 1520, a storage device 1530, and an input/output device 1540. Each of the components 1510, 1520, 1530, and 1540 can be interconnected, for example, using a system bus 1550. The processor 1510 can be capable of processing instructions for execution within the system 1500. The processor 1510 can be a single-threaded processor, a multi-threaded processor, or similar device. The processor 1510 can be capable of processing instructions stored in the memory 1520 or on the storage device 1530. The processor 1510 may execute operations such as meshing objects 701′, 702′, 800′, receiving 3D objects 701, 701 or 3D meshes 701′, 702′, 800′, minimum clearance or other constraints, various cost functions and/or associated constraints, increment ranges, and/or optimized data, such as sets of orientations and associated clearances and/or cost function results, and/or storing and comparing various orientations and/or cost functions described herein, among other features described in conjunction with the present disclosure.

The memory 1520 can store information within the system 1500. In some implementations, the memory 1520 can be a computer-readable medium. The memory 1520 can, for example, be a volatile memory unit or a non-volatile memory unit. In some implementations, the memory 1520 can store information related to wind turbine blades and cargo bays, cost functions, and optimization landscapes, among other information.

The storage device 1530 can be capable of providing mass storage for the system 1500. In some implementations, the storage device 1530 can be a non-transitory computer-readable medium. The storage device 1530 can include, for example, a hard disk device, an optical disk device, a solid-date drive, a flash drive, magnetic tape, and/or some other large capacity storage device. The storage device 1530 may alternatively be a cloud storage device, e.g., a logical storage device including multiple physical storage devices distributed on a network and accessed using a network. In some implementations, the information stored on the memory 1520 can also or instead be stored on the storage device 1530.

The input/output device 1540 can provide input/output operations for the system 1500. In some implementations, the input/output device 1540 can include one or more of network interface devices (e.g., an Ethernet card or an Infiniband interconnect), a serial communication device (e.g., an RS-232 10 port), and/or a wireless interface device (e.g., a short-range wireless communication device, an 802.7 card, a 3G wireless modem, a 4G wireless modem, a 5G wireless modem). In some implementations, the input/output device 1540 can include driver devices configured to receive input data and send output data to other input/output devices, e.g., a keyboard, a printer, and/or display devices. In some implementations, mobile computing devices, mobile communication devices, and other devices can be used.

In some implementations, the system 1500 can be a microcontroller. A microcontroller is a device that contains multiple elements of a computer system in a single electronics package. For example, the single electronics package could contain the processor 1510, the memory 1520, the storage device 1530, and/or input/output devices 1540.

Although an example processing system has been described above, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a processing system. The computer readable medium can be a machine-readable storage device, a machine-readable storage substrate, a memory device, a composition of matter effecting a machine-readable propagated signal, or a combination of one or more of them.

Various embodiments of the present disclosure may be implemented at least in part in any conventional computer programming language. For example, some embodiments may be implemented in a procedural programming language (e.g., “C” or ForTran95), or in an object-oriented programming language (e.g., “C++”). Other embodiments may be implemented as a pre-configured, stand-along hardware element and/or as preprogrammed hardware elements (e.g., application specific integrated circuits, FPGAs, and digital signal processors), or other related components.

The term “computer system” may encompass all apparatus, devices, and machines for processing data, including, by way of non-limiting examples, a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Such implementation may include a series of computer instructions fixed either on a tangible, non-transitory medium, such as a computer readable medium. The series of computer instructions can embody all or part of the functionality previously described herein with respect to the system. Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. The components of the system can be interconnected by any form or medium of digital data communication, e.g., a communication network. Examples of communication networks include a local area network (“LAN”) and a wide area network (“WAN”), e.g., the Internet.

Those skilled in the art should appreciate that such computer instructions can be written in a number of programming languages for use with many computer architectures or operating systems. Furthermore, such instructions may be stored in any memory device, such as semiconductor, magnetic, optical, or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the present disclosure may be implemented as a combination of both software (e.g., a computer program product) and hardware. Still other embodiments of the present disclosure are implemented as entirely hardware, or entirely software.

One skilled in the art will appreciate further features and advantages of the disclosures based on the provided for descriptions and embodiments. Accordingly, the inventions are not to be limited by what has been particularly shown and described. For example, although the present disclosure provides for transporting large cargo, such as wind turbines, the present disclosures can also be applied to other types of large cargo or to smaller cargo, at least some of which are mentioned above. All publications and references cited herein are expressly incorporated herein by reference in their entirety.

Examples of the above-described embodiments can include the following:

1. A computer-implemented method of optimizing a packaging orientation of large irregular payloads, the method comprising:
receiving, via an input operated by a processor, a first 3D surface geometry of a first object, a second 3D surface geometry of a second object, and a minimum clearance constraint;
calculating, using a processor, for an orientation of the first 3D surface geometry and an orientation of the second 3D surface geometry, a minimum clearance between the first 3D surface geometry and the second 3D surface geometry, the orientation of the second 3D surface geometry comprising three translational degrees of freedom and three rotational degrees of freedom;
comparing, using a processor, the calculated minimum clearance to the minimum clearance constraint;
storing, in a memory location in electrical communication with the processor, the orientation of the second 3D surface geometry and calculated minimum clearance if the calculated minimum clearance satisfies the minimum clearance constraint based on the comparing as a payload orientation with respect to the orientation of the first 3D surface geometry;
adjusting, using a processor, each of the three translational degrees of freedom and three rotational degrees of freedom of the second 3D surface geometry through a series of six nested loops, each of the six nested loops adjusting a corresponding degree of freedom through a corresponding range of increments in a separate layer of the series and, for each increment, repeating the calculating, comparing, and storing for a corresponding orientation of the second 3D surface geometry; and
outputting, via a processor, the stored payload orientations.
   2. The method of claim 1,
wherein the calculating further comprises calculating for the orientation of the first 3D surface geometry and the orientation of the second 3D surface geometry a 3D convex hull volume of the combined first and second 3D surface geometries, and
wherein the storing further comprises storing the calculated convex hull volume.
   3. The method of claim 2, further comprising:
after the adjusting, filtering the stored corresponding orientations of the second 3D surface geometry based on the calculated convex hull volume.
   4. The method of claim 2 or 3,
wherein calculating the 3D convex hull volume comprises:
   (a) calculating a plurality of 2D convex hull areas in a corresponding plurality of 2D planes each intersecting at least one of the first and second 3D surface geometries along a total length of the first and second 3D surface geometries; and
   (b) integrating the plurality of 2D convex hull areas along the total length.
      5. The method of claim 4, wherein each of the plurality of 2D convex hull areas is calculated using Green's theorem.
      6. The method of claim 4 or 5, wherein calculating the 3D convex hull volume further comprises calculating a bi-tangential connection between each of the first and second 3D surface geometries in a corresponding one of the plurality of 2D planes to build each of the plurality of 2D convex hull areas.
      7. The method of any of claims 2 to 6,
wherein each of the first and second 3D surface geometries defines a volume and the combined volumes of the first and second 3D surface geometries defines a total object volume,
wherein the calculating further comprises calculating a convex hull volume ratio between the calculated convex hull volume and the total object volume, and
wherein the storing further comprises storing the convex hull volume ratio with each payload orientation.
   8. The method of claim 7,
wherein the receiving further comprises receiving a convex hull constraint,
wherein the comparing further comprises comparing the calculated convex hull volume ratio to the convex hull constraint, and
wherein the storing further comprises storing the convex hull volume ratio and payload orientation if both the calculated minimum clearance satisfies the minimum clearance constraint and the calculated convex hull volume ratio satisfies the convex hull constraint based on the comparing.
   9. The method of any of claims 1 to 8,
wherein the receiving further comprises receiving a range constraint for at least one of the corresponding range of increments, and
wherein the adjusting further comprises at least one of the corresponding range of increments being based on the range constraint.
   10. The method of any of claims 1 to 9, wherein at least one of the corresponding range of increments comprises increments of a first spacing, the method further comprising:
after the adjusting and for each stored payload orientation, repeating the adjusting with an optimized range of increments in place of the corresponding range, the optimized range comprising increments of a second spacing, the second spacing being smaller than the first spacing, and the optimized range defining a reduced range compared to the corresponding range, the reduced range including the orientation of a corresponding one of each stored payload.
   11. The method of any of claims 1 to 10,
wherein the receiving further comprises receiving a cargo bay 3D surface geometry of a cargo bay volume and a minimum payload clearance constraint,
wherein the cargo bay 3D surface geometry defines a fixed cargo bay orientation,
wherein the orientation of the first 3D surface geometry comprises three translational degrees of freedom and three rotational degrees of freedom,
wherein the calculating further comprises calculating for the orientation of the first 3D surface geometry and the orientation of the second 3D surface geometry a minimum payload clearance between an exterior of the first and second 3D surface geometries and an interior of the cargo bay 3D surface,
wherein the comparing further comprises comparing the calculated minimum payload clearance to the minimum payload clearance constraint,
wherein the storing further comprises storing:
   (a) the orientations of the first and second 3D surfaces with respect to the fixed cargo bay orientation;
   (b) the calculated minimum clearance; and
   (c) the minimum payload clearance as the payload orientation if both:
      (i) the calculated minimum clearance satisfies the minimum clearance constraint; and
      (ii) the calculated minimum payload clearance satisfies the minimum payload clearance constrained based on the comparing,
wherein the adjusting further comprises adjusting each of the three translational degrees of freedom and three rotational degrees of freedom of the first 3D surface geometry through an additional series of six nested loops, each of the six nested loops of the additional series adjusting a corresponding degree of freedom through a corresponding range of increments in a separate layer of the additional series and, for each increment, repeating the calculating, comparing, and storing for a corresponding orientation of the first 3D surface geometry such that the series and the additional series form the single nested group.
   12. The method of claim 1,
wherein the cargo bay 3D surface geometry defines a centerline extending from a first end of the cargo bay volume to a second opposite end of the cargo bay volume,
wherein the receiving further comprises receiving a maximum centerline deviation constraint,
wherein the calculating further comprises calculating for the orientation of the first 3D surface geometry and the orientation of the second 3D surface geometry a maximum distance between an exterior of the first and second 3D surface geometries and the centerline measured substantially perpendicular to the centerline,
wherein the comparing further comprises comparing the calculated maximum distance to the maximum centerline deviation constraint payload clearance constraint, and
wherein the storing further includes storing (a), (b), and (c) if the calculated maximum distance satisfies the maximum centerline deviation constrained based on the comparing in addition to (i) and (ii).
   13. The method of claim 11 or 12,
wherein the cargo bay 3D surface geometry defines a cargo door opening into the interior of the cargo bay 3D surface geometry,
wherein the receiving further comprises receiving a minimum loading clearance constraint,
the method, further comprising:
   simulating, using a processor, for each stored orientation of the first and second 3D surface geometries, a loading operation along an input path of a 3D payload object having an exterior surface defined by the first and second 3D surface geometries in their stored orientation;
   calculating a minimum loading clearance between the exterior surface of the 3D payload and the interior of the cargo bay 3D surface geometry;
   comparing the calculated minimum loading clearance to the minimum loading clearance constraint; and
   outputting each 3D payload object that satisfies the minimum loading clearance constraint based on the comparing.
      14. The method of claim 13, wherein the calculating a minimum loading clearance between the exterior surface of the 3D payload and the interior of the cargo bay 3D surface geometry occurs during the simulating.
      15. The method of any of claims 11 to 14,
wherein the receiving further comprises receiving an initial orientation of the first 3D surface geometry and an initial orientation of the second 3D surface geometry, and
wherein the initial orientations of both the first and second 3D surface geometries are disposed inside the cargo bay 3D surface geometry in the fixed cargo bay orientation, the first and second 3D surface geometries being in the respective initial orientations before the adjusting.
   16. The method of claims 1 to 15,
wherein the input receives at least one or more 3D surface geometries of at least one or more objects,
wherein the calculating comprises calculating a minimum clearance between the first 3D surface geometry, the second 3D surface geometry, and each of the at least one or more 3D surface geometries for an orientation of the at least one or more 3D surface geometries, the orientation of the each of the at least one or more 3D surface geometries comprising three translational degrees of freedom and three rotational degrees of freedom,
wherein the storing comprises storing the orientation of the at least one or more 3D surface geometries in the payload orientation, and
wherein the adjusting comprises adjusting each of the three translational degrees of freedom and three rotational degrees of freedom of the at least one or more 3D surface geometries through a further series of six nested loops per each object of the at least one or more objects, each of the six nested loops of each further series adjusting a corresponding degree of freedom through a corresponding range of increments in a separate layer of the further series and, for each increment, repeating the calculating, comparing, and storing for a corresponding orientation of the 3D surface geometry of the at least one or more 3D surface geometries such that each series of the further series and the series form the single nested group, the single nested group further comprising the additional series when the additional series is present.
   17. The method of any of claims 1 to 16, wherein the adjusting further comprises, for at least one of the nested loops, adjusting the corresponding range of increments based on a trend of two or more previously calculated minimum clearances.
   18. The method of any of claims 1 to 17, wherein the first object comprises a first wind turbine blade and the second object comprises a second wind turbine blade.
   19. The method of claim 18, wherein when at least one or more objects are provided, a third object of the at least one or more objects is a third wind turbine blade.
   20. The method of claim 19, wherein a fourth object of the at least one or more objects is a fourth wind turbine blade.
   21. A computer system, comprising:
an input module configured to receive a first 3D surface geometry of a first object, a second 3D surface geometry of a second object, and a minimum clearance constraint;
a calculator module configured to calculate, for an orientation of the first 3D surface geometry and an orientation of the second 3D surface geometry, a minimum clearance between the first 3D surface geometry and the second 3D surface geometry, the orientation of the second 3D surface geometry comprising three translational degrees of freedom and three rotational degrees of freedom;
a comparer module configured to compare the calculated minimum clearance to the minimum clearance constraint;
a memory module configured to store the orientation of the second 3D surface geometry and calculated minimum clearance if the calculated minimum clearance satisfies the minimum clearance constraint based on the comparing as a payload orientation with respect to the orientation of the first 3D surface geometry;
an adjuster module configured to adjust each of the three translational degrees of freedom and three rotational degrees of freedom of the second 3D surface geometry through a series of six nested loops, each of the six nested loops adjusting a corresponding degree of freedom through a corresponding range of increments in a separate layer of the series and, for each increment, interfacing with the calculator module, the comparer module, and the memory module in order to repeat a calculating, comparing, and storing operation for a corresponding orientation of the second 3D surface geometry; and
an output configured to output the stored payload orientations.
   22. The system of claim 21,
wherein the calculator module is further configured to calculate, for the orientation of the first 3D surface geometry and the orientation of the second 3D surface geometry, a 3D convex hull volume of the combined first and second 3D surface geometries, and
wherein the memory module is further configured to store the calculated convex hull volume.
   23. The system of claim 22, further comprising:
a filtering module configured to, after the adjusting, filter the stored corresponding orientations of the second 3D surface geometry based on the calculated convex hull volume.
   24. The system of claim 22 or 23,
wherein the calculator module is further configured to calculate the 3D convex hull volume by:
   (a) calculating a plurality of 2D convex hull areas in a corresponding plurality of 2D planes each intersecting at least one of the first and second 3D surface geometries along a total length of the first and second 3D surface geometries; and
   (b) integrating the plurality of 2D convex hull areas along the total length.
      25. The system of claim 24, wherein each of the plurality of 2D convex hull areas is calculated using Green's theorem.
      26. The system of claim 24 or 25, wherein calculating the 3D convex hull volume further comprises calculating a bi-tangential connection between each of the first and second 3D surface geometries in a corresponding one of the plurality of 2D planes to build each of the plurality of 2D convex hull areas.
      27. The system of any of claims 21 to 26,
wherein each of the first and second 3D surface geometries defines a volume and the combined volumes of the first and second 3D surface geometries defines a total object volume,
wherein the calculator module is further configured to calculate a convex hull volume ratio between the calculated convex hull volume and the total object volume, and
wherein the memory module is further configured to store the convex hull volume ratio with each payload orientation.
   28. The system of claim 27,
wherein the input module is further configured to receive a convex hull constraint,
wherein the comparer module is further configured to compare the calculated convex hull volume ratio to the convex hull constraint, and
wherein the memory module is further configured to store the convex hull volume ratio and payload orientation if both the calculated minimum clearance satisfies the minimum clearance constraint and the calculated convex hull volume ratio satisfies the convex hull constraint based on the comparing.
   29. The method of any of claims 21 to 28,
wherein the input module is further configured to receive a range constraint for at least one of the corresponding range of increments, and
wherein the adjuster module is further configured to adjust at least one of the corresponding range of increments being based on the range constraint.
   30. The system of any of claims 21 to 29, wherein at least one of the corresponding range of increments comprises increments of a first spacing, the adjustor module being further configured to:
after the adjusting and for each stored payload orientation, repeat the adjusting with an optimized range of increments in place of the corresponding range, the optimized range comprising increments of a second spacing, the second spacing being smaller than the first spacing, and the optimized range defining a reduced range compared to the corresponding range, the reduced range including the orientation of a corresponding one of each stored payload.
   31. The system of any of claims 21 to 30,
wherein the input module is further configured to receive a cargo bay 3D surface geometry of a cargo bay volume and a minimum payload clearance constraint,
wherein the cargo bay 3D surface geometry defines a fixed cargo bay orientation,
wherein the orientation of the first 3D surface geometry comprises three translational degrees of freedom and three rotational degrees of freedom,
wherein the calculator module is further configured to calculate, for the orientation of the first 3D surface geometry and the orientation of the second 3D surface geometry, a minimum payload clearance between an exterior of the first and second 3D surface geometries and an interior of the cargo bay 3D surface,
wherein the comparer module is further configured to compare the calculated minimum payload clearance to the minimum payload clearance constraint,
wherein the memory module is further configured to store:
   (a) the orientations of the first and second 3D surfaces with respect to the fixed cargo bay orientation;
   (b) the calculated minimum clearance; and
   (c) the minimum payload clearance as the payload orientation if both:
      (i) the calculated minimum clearance satisfies the minimum clearance constraint; and
      (ii) the calculated minimum payload clearance satisfies the minimum payload clearance constrained based on the comparing,
wherein the adjustor module is further configured to adjust each of the three translational degrees of freedom and three rotational degrees of freedom of the first 3D surface geometry through an additional series of six nested loops, each of the six nested loops of the additional series adjusting a corresponding degree of freedom through a corresponding range of increments in a separate layer of the additional series and, for each increment, interfacing with each of the calculator module, the comparer module, and the storing module in order to repeat a calculating, comparing, and storing operation for a corresponding orientation of the first 3D surface geometry such that the series and the additional series form the single nested group.
   32. The system of claim 31,
wherein the cargo bay 3D surface geometry defines a centerline extending from a first end of the cargo bay volume to a second opposite end of the cargo bay volume,
wherein the receiving further comprises receiving a maximum centerline deviation constraint,
wherein the calculating further comprises calculating for the orientation of the first 3D surface geometry and the orientation of the second 3D surface geometry a maximum distance between an exterior of the first and second 3D surface geometries and the centerline measured substantially perpendicular to the centerline,
wherein the comparing further comprises comparing the calculated maximum distance to the maximum centerline deviation constraint payload clearance constraint, and
wherein the storing further includes storing (a), (b), and (c) if the calculated maximum distance satisfies the maximum centerline deviation constrained based on the comparing in addition to (i) and (ii).
   33. The system of claim 31 or 32,
wherein the cargo bay 3D surface geometry defines a cargo door opening into the interior of the cargo bay 3D surface geometry,
wherein the input is further configured to receive a minimum loading clearance constraint,
the system, further comprising:
   a simulator module configured to, for each stored orientation of the first and second 3D surface geometries, simulate a loading operation along an input path of a 3D payload object having an exterior surface defined by the first and second 3D surface geometries in their stored orientation;
   wherein, the calculator module is further configured to calculate a minimum loading clearance between the exterior surface of the 3D payload and the interior of the cargo bay 3D surface geometry;
   wherein the comparer module is further configured to compare the calculated minimum loading clearance to the minimum loading clearance constraint; and
   wherein the output module is further configured to output each 3D payload object that satisfies the minimum loading clearance constraint based on the comparing.
      34. The system of claim 33, wherein the calculator module is further configured to calculate the minimum loading clearance between the exterior surface of the 3D payload and the interior of the cargo bay 3D surface geometry during the simulating.
      35. The system of any of claims 31 to 34,
wherein the input module is further configured to receive an initial orientation of the first 3D surface geometry and an initial orientation of the second 3D surface geometry, and
wherein the initial orientations of both the first and second 3D surface geometries are disposed inside the cargo bay 3D surface geometry in the fixed cargo bay orientation, the first and second 3D surface geometries being in the respective initial orientations before the adjusting.
   36. The system of claims 21 to 35,
wherein the input module is configured to receive at least one or more 3D surface geometries of at least one or more objects,
wherein the calculator module is further configured to calculate a minimum clearance between the first 3D surface geometry, the second 3D surface geometry, and each of the at least one or more 3D surface geometries for an orientation of the at least one or more 3D surface geometries, the orientation of the each of the at least one or more 3D surface geometries comprising three translational degrees of freedom and three rotational degrees of freedom,
wherein the memory module is further configured to store the orientation of the at least one or more 3D surface geometries in the payload orientation, and
wherein the adjustor module is further configured to adjust each of the three translational degrees of freedom and three rotational degrees of freedom of the at least one or more 3D surface geometries through a further series of six nested loops per each object of the at least one or more objects, each of the six nested loops of each further series adjusting a corresponding degree of freedom through a corresponding range of increments in a separate layer of the further series and, for each increment, call the calculator module, comparer module, and the memory module to repeat a calculating, comparing, and storing operations for a corresponding orientation of the 3D surface geometry of the at least one or more 3D surface geometries such that each series of the further series and the series form the single nested group, the single nested group further comprising the additional series when the additional series is present.
   37. The system of any of claims 21 to 36, wherein the adjustor module is further configured to adjust, for at least one of the nested loops, the corresponding range of increments based on a trend of two or more previously calculated minimum clearances.
   38. The system of any of claims 21 to 37, wherein the first object comprises a first wind turbine blade and the second object comprises a second wind turbine blade.
   39. The system of claim 38, wherein when at least one or more objects are provided, a third object of the at least one or more objects is a third wind turbine blade.
   40. The system of claim 39, wherein a fourth object of the at least one or more objects is a fourth wind turbine blade.
   41. A computer program product, comprising a tangible, non-transient computer usable medium having computer readable program code thereon, the computer readable program code comprising program code configured to:
receive, via an input operated by a processor, a first 3D surface geometry of a first object, a second 3D surface geometry of a second object, and a minimum clearance constraint;
calculate, using a processor, for an orientation of the first 3D surface geometry and an orientation of the second 3D surface geometry, a minimum clearance between the first 3D surface geometry and the second 3D surface geometry, the orientation of the second 3D surface geometry comprising three translational degrees of freedom and three rotational degrees of freedom;
compare, using a processor, the calculated minimum clearance to the minimum clearance constraint;
store, in a memory location in electrical communication with the processor, the orientation of the second 3D surface geometry and calculated minimum clearance if the calculated minimum clearance satisfies the minimum clearance constraint based on the comparing as a payload orientation with respect to the orientation of the first 3D surface geometry;
adjust, using a processor, each of the three translational degrees of freedom and three rotational degrees of freedom of the second 3D surface geometry through a series of six nested loops, each of the six nested loops adjusting a corresponding degree of freedom through a corresponding range of increments in a separate layer of the series and, for each increment, repeating the calculate, compare, and store operations for a corresponding orientation of the second 3D surface geometry; and
output, via a processor, the stored payload orientations.
   42. The computer program product of claim 41,
wherein the program code is further configured to calculate, for the orientation of the first 3D surface geometry and the orientation of the second 3D surface geometry, a 3D convex hull volume of the combined first and second 3D surface geometries, and
wherein the program code is further configured to store the calculated convex hull volume.
   43. The computer program product of claim 42, further comprising:
program code configured to, after the adjusting, filter the stored corresponding orientations of the second 3D surface geometry based on the calculated convex hull volume.
   44. The computer program product of claim 42 or 43,
wherein to calculate the 3D convex hull volume comprises instructions:
   (a) calculate a plurality of 2D convex hull areas in a corresponding plurality of 2D planes each intersecting at least one of the first and second 3D surface geometries along a total length of the first and second 3D surface geometries; and
   (b) integrate the plurality of 2D convex hull areas along the total length.
      45. The computer program product of claim 44, wherein each of the plurality of 2D convex hull areas is calculated using Green's theorem.
      46. The computer program product of claim 44 or 45, wherein the program code to calculate the 3D convex hull volume further include program code to calculate a bi-tangential connection between each of the first and second 3D surface geometries in a corresponding one of the plurality of 2D planes to build each of the plurality of 2D convex hull areas.
      47. The computer program product of any of claims 42 to 46,
wherein each of the first and second 3D surface geometries defines a volume and the combined volumes of the first and second 3D surface geometries defines a total object volume,
wherein the program code to calculate further comprises program code to calculate a convex hull volume ratio between the calculated convex hull volume and the total object volume, and
wherein the program code to store further comprises program code to store the convex hull volume ratio with each payload orientation.
   48. The computer program product of claim 47,
wherein the program code to receive further comprises program code to receive a convex hull constraint,
wherein the program code to compare further comprises program code to compare the calculated convex hull volume ratio to the convex hull constraint, and
wherein the program code to store further comprises program code to store the convex hull volume ratio and payload orientation if both the calculated minimum clearance satisfies the minimum clearance constraint and the calculated convex hull volume ratio satisfies the convex hull constraint based on the comparing.
   49. The computer program product of any of claims 41 to 48,
wherein the program code to receive further comprises program code to receive a range constraint for at least one of the corresponding range of increments, and
wherein the program code to adjust further comprises program code to adjust at least one of the corresponding range of increments being based on the range constraint.
   50. The computer program product of any of claims 41 to 49, wherein at least one of the corresponding range of increments comprises increments of a first spacing, the program code comprising:
program code to, after the adjust operation and for each stored payload orientation, repeating the adjust operation with an optimized range of increments in place of the corresponding range, the optimized range comprising increments of a second spacing, the second spacing being smaller than the first spacing, and the optimized range defining a reduced range compared to the corresponding range, the reduced range including the orientation of a corresponding one of each stored payload.
   51. The computer program product of any of claims 41 to 50,
wherein program code to receive further comprises program code to receive a cargo bay 3D surface geometry of a cargo bay volume and a minimum payload clearance constraint,
wherein the cargo bay 3D surface geometry defines a fixed cargo bay orientation,
wherein the orientation of the first 3D surface geometry comprises three translational degrees of freedom and three rotational degrees of freedom,
wherein the program code to calculate further comprises program code to calculate, for the orientation of the first 3D surface geometry and the orientation of the second 3D surface geometry, a minimum payload clearance between an exterior of the first and second 3D surface geometries and an interior of the cargo bay 3D surface,
wherein the program code to compare further comprises program code to compare the calculated minimum payload clearance to the minimum payload clearance constraint,
wherein the program code to store further comprises program code to store:
   (a) the orientations of the first and second 3D surfaces with respect to the fixed cargo bay orientation;
   (b) the calculated minimum clearance; and
   (c) the minimum payload clearance as the payload orientation if both:
      (i) a calculated minimum clearance satisfies the minimum clearance constraint; and
      (ii) a calculated minimum payload clearance satisfies the minimum payload clearance constrained based on the comparing,
wherein the program code to adjust further comprises program code to adjust each of the three translational degrees of freedom and three rotational degrees of freedom of the first 3D surface geometry through an additional series of six nested loops, each of the six nested loops of the additional series adjusting a corresponding degree of freedom through a corresponding range of increments in a separate layer of the additional series and, for each increment, repeating the calculate, compare, and store operation for a corresponding orientation of the first 3D surface geometry such that the series and the additional series form the single nested group.
   52. The computer program product of claim 51,
wherein the cargo bay 3D surface geometry defines a centerline extending from a first end of the cargo bay volume to a second opposite end of the cargo bay volume,
wherein the program code to receive further include program code to recieve a maximum centerline deviation constraint,
wherein the program code to calculate further comprises program code to calculate, for the orientation of the first 3D surface geometry and the orientation of the second 3D surface geometry, a maximum distance between an exterior of the first and second 3D surface geometries and the centerline measured substantially perpendicular to the centerline,
wherein the program code to compare further comprises program code to compare the calculated maximum distance to the maximum centerline deviation constraint payload clearance constraint, and
wherein the program code to sore further includes program code to store (a), (b), and (c) if the calculated maximum distance satisfies the maximum centerline deviation constrained based on the comparing in addition to (i) and (ii).
   53. The computer program product of claim 51 or 52,
wherein the cargo bay 3D surface geometry defines a cargo door opening into the interior of the cargo bay 3D surface geometry,
wherein the program code to receive further comprises program code to receive a minimum loading clearance constraint,
the method, further comprising program code to:
   simulate, for each stored orientation of the first and second 3D surface geometries, a loading operation along an input path of a 3D payload object having an exterior surface defined by the first and second 3D surface geometries in their stored orientation;
   calculate a minimum loading clearance between the exterior surface of the 3D payload and the interior of the cargo bay 3D surface geometry;
   compare the calculated minimum loading clearance to the minimum loading clearance constraint; and
   output each 3D payload object that satisfies the minimum loading clearance constraint based on the comparing.
      54. The computer program product of claim 53, wherein the program code to calculating a minimum loading clearance between the exterior surface of the 3D payload and the interior of the cargo bay 3D surface geometry is configured to operate during the program code to simulate.
      55. The computer program product of any of claims 41 to 54,
wherein the program code to receive further comprises program code to receive an initial orientation of the first 3D surface geometry and an initial orientation of the second 3D surface geometry, and
wherein the initial orientations of both the first and second 3D surface geometries are disposed inside the cargo bay 3D surface geometry in the fixed cargo bay orientation, the first and second 3D surface geometries being in the respective initial orientations before the adjust operation.
   56. The computer program product of claims 41 to 55,
wherein program code to receive include program code to receive at least one or more 3D surface geometries of at least one or more objects,
wherein the program code to calculate comprises program code to calculate a minimum clearance between the first 3D surface geometry, the second 3D surface geometry, and each of the at least one or more 3D surface geometries for an orientation of the at least one or more 3D surface geometries, the orientation of the each of the at least one or more 3D surface geometries comprising three translational degrees of freedom and three rotational degrees of freedom,
wherein the program code to store comprises program code to store the orientation of the at least one or more 3D surface geometries in the payload orientation, and
wherein the program code to adjust comprises program code to adjust each of the three translational degrees of freedom and three rotational degrees of freedom of the at least one or more 3D surface geometries through a further series of six nested loops per each object of the at least one or more objects, each of the six nested loops of each further series adjusting a corresponding degree of freedom through a corresponding range of increments in a separate layer of the further series and, for each increment, repeating the calculate, compare, and store operation for a corresponding orientation of the 3D surface geometry of the at least one or more 3D surface geometries such that each series of the further series and the series form the single nested group, the single nested group further comprising the additional series when the additional series is present.
   57. The computer program product of any of claims 41 to 56, wherein the program code to adjust further comprises program code to adjust, for at least one of the nested loops, the corresponding range of increments based on a trend of two or more previously calculated minimum clearances.
   58. The computer program product of any of claims 41 to 57, wherein the first object comprises a first wind turbine blade and the second object comprises a second wind turbine blade.
   59. The computer program product of claim 58, wherein when at least one or more objects are provided, a third object of the at least one or more objects is a third wind turbine blade.
   60. The computer program product of claim 59, wherein a fourth object of the at least one or more objects is a fourth wind turbine blade.
   61. A computer-implemented method of optimizing a packaging orientation of large irregular payloads, the method comprising:
receiving, via an input operated by a processor, a first 3D surface geometry of a first object, and at least a second 3D surface geometry of a second object (but possibly numerous other 3D surface geometries of other objects), and a required inter-object clearance constraint;
calculating, using a processor, for an orientation of the first 3D surface geometry and an orientation of each additional 3D surface geometry, an inter-object clearance between the first 3D surface geometry and each additional 3D surface geometry, the orientation of the additional surface geometries comprising three translational degrees of freedom and three rotational degrees of freedom between specified ranges for each degree of freedom;
comparing, using a processor, the calculated inter-object clearance to the input required inter-object clearance constraint;
storing, in a memory location in electrical communication with the processor, the orientation of each additional 3D surface and calculated inter-object clearance if the calculated inter-object clearance satisfies the required inter-object clearance constraint based on the comparing as a payload orientation with respect to the orientation of each 3D surface geometry;
adjusting, using a processor, each of the three translational degrees of freedom and three rotational degrees of freedom of the additional 3D surface geometries through a series of six nested loops per geometry, each of the six nested loops adjusting a corresponding degree of freedom through a corresponding range of increments in a separate layer of the series and, for each increment, repeating the calculating, comparing, and storing for a corresponding orientation of the additional 3D surface geometries; and
outputting, via a processor, the stored payload orientations.
   62. The method of claim 61,
wherein the calculating further comprises calculating for the orientation of the first 3D surface geometry and the orientation of the additional 3D surface geometries a 3D convex hull volume of the combined first and second 3D surface geometries, and
wherein the storing further comprises storing the calculated convex hull volume.
   63. The method of claim 62, further comprising:
after the adjusting, filtering the stored corresponding orientations of the additional 3D surface geometries based on the calculated convex hull volume.
   64. The method of claim 62 or 63,
wherein calculating the 3D convex hull volume comprises:
   (a) calculating a plurality of 2D convex hull areas in a corresponding plurality of 2D planes each intersecting at least one of the 3D surface geometries along a total length of the 3D surface geometries; and
   (b) integrating the plurality of 2D convex hull areas along the total length to approximate the 3D convex hull efficiently and with reasonable accuracy, neglecting only to encapsulate curvature orthogonal to the 2D planes into the approximated 3D convex hull.
      65. The method of claim 64, wherein each of the plurality of 2D convex hull areas is calculated using Green's theorem.
      66. The method of claim 64 or 65, wherein calculating the 3D convex hull volume further comprises calculating a bi-tangential connection between each 3D surface geometry in a corresponding one of the plurality of 2D planes to build each of the plurality of 2D convex hull areas.
      67. The method of any of claims 62 to 66,
wherein each of the first and additional 3D surface geometries defines a volume and the combined sum of the volumes of the first and additional 3D surface geometries defines a total object volume, which is obviously the minimum amount of volume which can be taken up by the combination of rigid objects,
wherein the calculating further comprises calculating a convex hull volume ratio equal to the aforementioned calculated convex hull volume divided by the aforementioned total object volume,
wherein the convex hull volume to total object volume ratio or “Convex Hull Volume Ratio Parameter” (CHVRP″) defines a type of packaging efficiency of the current packaging volume utilized divided by the minimum potential packaging volume for objects which nest together perfectly, such that perfect packages have CHVRP of unity and
wherein the storing further comprises storing the CHVRP with each payload orientation.
   68. The method of claim 67,
wherein the receiving further comprises determining a minimum convex hull ratio constraint by finding the minimum value of CHVRP over all orientations of all additional 3D surface geometries relative to the first 3D surface geometry, and
wherein the storing further comprises storing the convex hull volume ratio and payload.
   69. The method of any of claims 61 to 68,
wherein the receiving further comprises receiving a range constraint for at least one of the corresponding range of increments for each degree of freedom, and
wherein the adjusting further comprises at least one of the corresponding range of increments being based on the range constraint for each degree of freedom.
   70. The method of any of claims 61 to 69, wherein at least one of the corresponding range of increments comprises increments of a first spacing, the method further comprising:
after the adjusting and for each stored payload orientation, repeating the adjusting with an optimized range of increments in place of the corresponding range, the optimized range comprising increments of a second spacing, the second spacing being smaller than the first spacing, and the optimized range defining a reduced range compared to the corresponding range, the reduced range including the orientation of a corresponding one of each stored payload.
   71. The method of any of claims 61 to 70,
wherein the receiving further comprises receiving a cargo bay 3D surface geometry of a known cargo bay volume,
wherein the cargo bay 3D surface geometry defines a fixed cargo bay orientation,
wherein the orientation of the first 3D surface geometry comprises three translational degrees of freedom and three rotational degrees of freedom,
wherein the calculating further comprises calculating for the orientation of each 3D surface geometry and a payload/cargo bay clearance between the exterior of the closest of the 3D surface geometries and an interior of the cargo bay 3D surface,
wherein the storing further comprises storing:
   (a) the orientations of each 3D surface with respect to the fixed cargo bay orientation;
   (b) the calculated inter-object clearance; and
   (c) the minimum payload/cargo bay clearance of the payload orientation,
wherein the adjusting further comprises adjusting each of the three translational degrees of freedom and three rotational degrees of freedom of each 3D surface geometry through an additional series of six nested loops apiece, each of the six nested loops of the additional series adjusting a corresponding degree of freedom through a corresponding range of increments in a separate layer of the additional series and, for each increment, repeating the calculating, comparing, and storing for a corresponding orientation of each 3D surface geometry such that the series and the additional series form the single nested group.
   72. The method of claim 71,
wherein an unknown cargo bay 3D surface geometry is defined only by a centerline extending from a first end of an otherwise unknown cargo bay volume to a second opposite end of an otherwise unknown cargo bay volume,
wherein the calculating further comprises calculating for the orientation of each 3D surface geometry a maximum distance between the exterior of each 3D surface geometry and the centerline measured substantially perpendicular to the centerline, and
wherein the storing further includes storing the calculated payload centerline deviation.
   73. The method of claim 71 or 72,
wherein the cargo bay 3D surface geometry defines a cargo door opening into the interior of the cargo bay 3D surface geometry,
the method, further comprising:
   simulating, using a processor, for each stored orientation of each 3D surface geometry, a loading or unloading operation of a 3D payload object having an exterior surface defined by each 3D surface geometry in numerous orientations along an input path during a loading and/or unloading operation;
   calculating a minimum loading clearance between the exterior surface of the 3D payload and the interior of the cargo bay 3D surface geometry;
   outputting each 3D payload orientation with a corresponding calculated minimum loading clearance.
      74. The method of claim 73, wherein the calculating a minimum loading clearance between the exterior surface of the 3D payload and the interior of the cargo bay 3D surface geometry occurs during the simulating.
      75. The method of any of claims 71 to 74
wherein the receiving further comprises receiving an initial orientation of the first 3D surface geometry and an initial orientation of the second 3D surface geometry, and
wherein the initial orientations of both the first and second 3D surface geometries are disposed inside the cargo bay 3D surface geometry in the fixed cargo bay orientation, the first and second 3D surface geometries being in the respective initial orientations before the adjusting.
   76. The method of claims 61 to 75,
wherein the input receives at least one or more 3D surface geometries of at least one or more objects,
wherein the calculating comprises calculating a minimum clearance between the first 3D surface geometry, the second 3D surface geometry, and each of the at least one or more 3D surface geometries for an orientation of the at least one or more 3D surface geometries, the orientation of the each of the at least one or more 3D surface geometries comprising three translational degrees of freedom and three rotational degrees of freedom,
wherein the storing comprises storing the orientation of the at least one or more 3D surface geometries in the payload orientation, and
wherein the adjusting comprises adjusting each of the three translational degrees of freedom and three rotational degrees of freedom of the at least one or more 3D surface geometries through a further series of six nested loops per each object of the at least one or more objects, each of the six nested loops of each further series adjusting a corresponding degree of freedom through a corresponding range of increments in a separate layer of the further series and, for each increment, repeating the calculating, comparing, and storing for a corresponding orientation of the 3D surface geometry of the at least one or more 3D surface geometries such that each series of the further series and the series form the single nested group, the single nested group further comprising the additional series when the additional series is present.
   77. The method of any of claims 61 to 76, wherein the adjusting further comprises, for at least one of the nested loops, adjusting the corresponding range of increments based on a trend of two or more previously calculated interobject clearances.

1. A computer-implemented method of optimizing a packaging orientation of large irregular payloads, the method comprising:
receiving, via an input operated by a processor, a first 3D surface geometry of a first object, a second 3D surface geometry of a second object, and a minimum clearance constraint;
calculating, using a processor, for an orientation of the first 3D surface geometry and an orientation of the second 3D surface geometry, a minimum clearance between the first 3D surface geometry and the second 3D surface geometry, the orientation of the second 3D surface geometry comprising three translational degrees of freedom and three rotational degrees of freedom;
comparing, using a processor, the calculated minimum clearance to the minimum clearance constraint;
storing, in a memory location in electrical communication with the processor, the orientation of the second 3D surface geometry and calculated minimum clearance if the calculated minimum clearance satisfies the minimum clearance constraint based on the comparing as a payload orientation with respect to the orientation of the first 3D surface geometry;
adjusting, using a processor, each of the three translational degrees of freedom and three rotational degrees of freedom of the second 3D surface geometry through a series of six nested loops, each of the six nested loops adjusting a corresponding degree of freedom through a corresponding range of increments in a separate layer of the series and, for each increment, repeating the calculating, comparing, and storing for a corresponding orientation of the second 3D surface geometry; and
outputting, via a processor, the stored payload orientations.

2. The method of claim 1,
wherein the calculating further comprises calculating for the orientation of the first 3D surface geometry and the orientation of the second 3D surface geometry a 3D convex hull volume of the combined first and second 3D surface geometries, and
wherein the storing further comprises storing the calculated convex hull volume.

3. The method of claim 2, further comprising:
after the adjusting, filtering the stored corresponding orientations of the second 3D surface geometry based on the calculated convex hull volume.

4. The method of claim 2,
wherein calculating the 3D convex hull volume comprises:
(a) calculating a plurality of 2D convex hull areas in a corresponding plurality of 2D planes each intersecting at least one of the first and second 3D surface geometries along a total length of the first and second 3D surface geometries; and
(b) integrating the plurality of 2D convex hull areas along the total length.

5. The method of claim 4,
wherein each of the plurality of 2D convex hull areas is calculated using Green's theorem.

6. The method of claim 4,
wherein calculating the 3D convex hull volume further comprises calculating a bi-tangential connection between each of the first and second 3D surface geometries in a corresponding one of the plurality of 2D planes to build each of the plurality of 2D convex hull areas.

7. The method of claim 2,
wherein each of the first and second 3D surface geometries defines a volume and the combined volumes of the first and second 3D surface geometries defines a total object volume,
wherein the calculating further comprises calculating a convex hull volume ratio between the calculated convex hull volume and the total object volume, and
wherein the storing further comprises storing the convex hull volume ratio with each payload orientation.

8. The method of claim 7,
wherein the receiving further comprises receiving a convex hull constraint,
wherein the comparing further comprises comparing the calculated convex hull volume ratio to the convex hull constraint, and
wherein the storing further comprises storing the convex hull volume ratio and payload orientation if both the calculated minimum clearance satisfies the minimum clearance constraint and the calculated convex hull volume ratio satisfies the convex hull constraint based on the comparing.

9. The method of claim 1,
wherein the receiving further comprises receiving a range constraint for at least one of the corresponding range of increments, and
wherein the adjusting further comprises at least one of the corresponding range of increments being based on the range constraint.

10. The method of claim 1, wherein at least one of the corresponding range of increments comprises increments of a first spacing, the method further comprising:
after the adjusting and for each stored payload orientation, repeating the adjusting with an optimized range of increments in place of the corresponding range, the optimized range comprising increments of a second spacing, the second spacing being smaller than the first spacing, and the optimized range defining a reduced range compared to the corresponding range, the reduced range including the orientation of a corresponding one of each stored payload.

11. The method of claim 1,
wherein the receiving further comprises receiving a cargo bay 3D surface geometry of a cargo bay volume and a minimum payload clearance constraint,
wherein the cargo bay 3D surface geometry defines a fixed cargo bay orientation,
wherein the orientation of the first 3D surface geometry comprises three translational degrees of freedom and three rotational degrees of freedom,
wherein the calculating further comprises calculating for the orientation of the first 3D surface geometry and the orientation of the second 3D surface geometry a minimum payload clearance between an exterior of the first and second 3D surface geometries and an interior of the cargo bay 3D surface,
wherein the comparing further comprises comparing the calculated minimum payload clearance to the minimum payload clearance constraint,
wherein the storing further comprises storing:
(a) the orientations of the first and second 3D surfaces with respect to the fixed cargo bay orientation;
(b) the calculated minimum clearance; and
(c) the minimum payload clearance as the payload orientation if both:
(i) the calculated minimum clearance satisfies the minimum clearance constraint; and
(ii) the calculated minimum payload clearance satisfies the minimum payload clearance constrained based on the comparing,
wherein the adjusting further comprises adjusting each of the three translational degrees of freedom and three rotational degrees of freedom of the first 3D surface geometry through an additional series of six nested loops, each of the six nested loops of the additional series adjusting a corresponding degree of freedom through a corresponding range of increments in a separate layer of the additional series and, for each increment, repeating the calculating, comparing, and storing for a corresponding orientation of the first 3D surface geometry such that the series and the additional series form the single nested group.

12. The method of claim 11,
wherein the cargo bay 3D surface geometry defines a centerline extending from a first end of the cargo bay volume to a second opposite end of the cargo bay volume,
wherein the receiving further comprises receiving a maximum centerline deviation constraint,
wherein the calculating further comprises calculating for the orientation of the first 3D surface geometry and the orientation of the second 3D surface geometry a maximum distance between an exterior of the first and second 3D surface geometries and the centerline measured substantially perpendicular to the centerline,
wherein the comparing further comprises comparing the calculated maximum distance to the maximum centerline deviation constraint payload clearance constraint, and
wherein the storing further includes storing (a), (b), and (c) if the calculated maximum distance satisfies the maximum centerline deviation constrained based on the comparing in addition to (i) and (ii).

13. The method of claim 11,
wherein the cargo bay 3D surface geometry defines a cargo door opening into the interior of the cargo bay 3D surface geometry,
wherein the receiving further comprises receiving a minimum loading clearance constraint,
the method, further comprising:
simulating, using a processor, for each stored orientation of the first and second 3D surface geometries, a loading operation along an input path of a 3D payload object having an exterior surface defined by the first and second 3D surface geometries in their stored orientation;
calculating a minimum loading clearance between the exterior surface of the 3D payload and the interior of the cargo bay 3D surface geometry;
comparing the calculated minimum loading clearance to the minimum loading clearance constraint; and
outputting each 3D payload object that satisfies the minimum loading clearance constraint based on the comparing.

14. The method of claim 13,
wherein the calculating a minimum loading clearance between the exterior surface of the 3D payload and the interior of the cargo bay 3D surface geometry occurs during the simulating.

15. The method of claim 11,
wherein the receiving further comprises receiving an initial orientation of the first 3D surface geometry and an initial orientation of the second 3D surface geometry, and
wherein the initial orientations of both the first and second 3D surface geometries are disposed inside the cargo bay 3D surface geometry in the fixed cargo bay orientation, the first and second 3D surface geometries being in the respective initial orientations before the adjusting.

16. The method of claim 15,
wherein the input receives at least one or more 3D surface geometries of at least one or more objects,
wherein the calculating comprises calculating a minimum clearance between the first 3D surface geometry, the second 3D surface geometry, and each of the at least one or more 3D surface geometries for an orientation of the at least one or more 3D surface geometries, the orientation of the each of the at least one or more 3D surface geometries comprising three translational degrees of freedom and three rotational degrees of freedom,
wherein the storing comprises storing the orientation of the at least one or more 3D surface geometries in the payload orientation, and
wherein the adjusting comprises adjusting each of the three translational degrees of freedom and three rotational degrees of freedom of the at least one or more 3D surface geometries through a further series of six nested loops per each object of the at least one or more objects, each of the six nested loops of each further series adjusting a corresponding degree of freedom through a corresponding range of increments in a separate layer of the further series and, for each increment, repeating the calculating, comparing, and storing for a corresponding orientation of the 3D surface geometry of the at least one or more 3D surface geometries such that each series of the further series and the series form the single nested group, the single nested group further comprising the additional series when the additional series is present.

17. The method of claim 1, wherein the adjusting further comprises, for at least one of the nested loops, adjusting the corresponding range of increments based on a trend of two or more previously calculated minimum clearances.

18. The method of claim 1, wherein the first object comprises a first wind turbine blade and the second object comprises a second wind turbine blade.

19. (canceled)

20. (canceled)

21. A computer system, comprising:
an input module configured to receive a first 3D surface geometry of a first object, a second 3D surface geometry of a second object, and a minimum clearance constraint;
a calculator module configured to calculate, for an orientation of the first 3D surface geometry and an orientation of the second 3D surface geometry, a minimum clearance between the first 3D surface geometry and the second 3D surface geometry, the orientation of the second 3D surface geometry comprising three translational degrees of freedom and three rotational degrees of freedom;
a comparer module configured to compare the calculated minimum clearance to the minimum clearance constraint;
a memory module configured to store the orientation of the second 3D surface geometry and calculated minimum clearance if the calculated minimum clearance satisfies the minimum clearance constraint based on the comparing as a payload orientation with respect to the orientation of the first 3D surface geometry;
an adjuster module configured to adjust each of the three translational degrees of freedom and three rotational degrees of freedom of the second 3D surface geometry through a series of six nested loops, each of the six nested loops adjusting a corresponding degree of freedom through a corresponding range of increments in a separate layer of the series and, for each increment, interfacing with the calculator module, the comparer module, and the memory module in order to repeat a calculating, comparing, and storing operation for a corresponding orientation of the second 3D surface geometry; and
an output configured to output the stored payload orientations.

22. The system of claim 21,
wherein the calculator module is further configured to calculate, for the orientation of the first 3D surface geometry and the orientation of the second 3D surface geometry, a 3D convex hull volume of the combined first and second 3D surface geometries, and
wherein the memory module is further configured to store the calculated convex hull volume.

23. The system of claim 22, further comprising:
a filtering module configured to, after the adjusting, filter the stored corresponding orientations of the second 3D surface geometry based on the calculated convex hull volume.

24. The system of claim 22,
wherein the calculator module is further configured to calculate the 3D convex hull volume by:
(a) calculating a plurality of 2D convex hull areas in a corresponding plurality of 2D planes each intersecting at least one of the first and second 3D surface geometries along a total length of the first and second 3D surface geometries; and
(b) integrating the plurality of 2D convex hull areas along the total length.

25. (canceled)

26. (canceled)

27. The system of claim 21,
wherein each of the first and second 3D surface geometries defines a volume and the combined volumes of the first and second 3D surface geometries defines a total object volume,
wherein the calculator module is further configured to calculate a convex hull volume ratio between the calculated convex hull volume and the total object volume, and
wherein the memory module is further configured to store the convex hull volume ratio with each payload orientation.

28. (canceled)

29. The system of claim 21,
wherein the input module is further configured to receive a range constraint for at least one of the corresponding range of increments, and
wherein the adjuster module is further configured to adjust at least one of the corresponding range of increments being based on the range constraint.

30. The system of claim 21, wherein at least one of the corresponding range of increments comprises increments of a first spacing, the adjustor module being further configured to:
after the adjusting and for each stored payload orientation, repeat the adjusting with an optimized range of increments in place of the corresponding range, the optimized range comprising increments of a second spacing, the second spacing being smaller than the first spacing, and the optimized range defining a reduced range compared to the corresponding range, the reduced range including the orientation of a corresponding one of each stored payload.

31. The system of claim 21,
wherein the input module is further configured to receive a cargo bay 3D surface geometry of a cargo bay volume and a minimum payload clearance constraint,
wherein the cargo bay 3D surface geometry defines a fixed cargo bay orientation,
wherein the orientation of the first 3D surface geometry comprises three translational degrees of freedom and three rotational degrees of freedom,
wherein the calculator module is further configured to calculate, for the orientation of the first 3D surface geometry and the orientation of the second 3D surface geometry, a minimum payload clearance between an exterior of the first and second 3D surface geometries and an interior of the cargo bay 3D surface,
wherein the comparer module is further configured to compare the calculated minimum payload clearance to the minimum payload clearance constraint,
wherein the memory module is further configured to store:
(a) the orientations of the first and second 3D surfaces with respect to the fixed cargo bay orientation;
(b) the calculated minimum clearance; and
(c) the minimum payload clearance as the payload orientation if both:
(i) the calculated minimum clearance satisfies the minimum clearance constraint; and
(ii) the calculated minimum payload clearance satisfies the minimum payload clearance constrained based on the comparing,
wherein the adjustor module is further configured to adjust each of the three translational degrees of freedom and three rotational degrees of freedom of the first 3D surface geometry through an additional series of six nested loops, each of the six nested loops of the additional series adjusting a corresponding degree of freedom through a corresponding range of increments in a separate layer of the additional series and, for each increment, interfacing with each of the calculator module, the comparer module, and the storing module in order to repeat a calculating, comparing, and storing operation for a corresponding orientation of the first 3D surface geometry such that the series and the additional series form the single nested group.

32-35. (canceled)

36. The system of claim 21,
wherein the input module is configured to receive at least one or more 3D surface geometries of at least one or more objects,
wherein the calculator module is further configured to calculate a minimum clearance between the first 3D surface geometry, the second 3D surface geometry, and each of the at least one or more 3D surface geometries for an orientation of the at least one or more 3D surface geometries, the orientation of the each of the at least one or more 3D surface geometries comprising three translational degrees of freedom and three rotational degrees of freedom,
wherein the memory module is further configured to store the orientation of the at least one or more 3D surface geometries in the payload orientation, and
wherein the adjustor module is further configured to adjust each of the three translational degrees of freedom and three rotational degrees of freedom of the at least one or more 3D surface geometries through a further series of six nested loops per each object of the at least one or more objects, each of the six nested loops of each further series adjusting a corresponding degree of freedom through a corresponding range of increments in a separate layer of the further series and, for each increment, call the calculator module, comparer module, and the memory module to repeat a calculating, comparing, and storing operations for a corresponding orientation of the 3D surface geometry of the at least one or more 3D surface geometries such that each series of the further series and the series form the single nested group, the single nested group further comprising the additional series when the additional series is present.

37. The system of claim 21,
wherein the adjustor module is further configured to adjust, for at least one of the nested loops, the corresponding range of increments based on a trend of two or more previously calculated minimum clearances.

38-40. (canceled)

41. A computer program product, comprising a tangible, non-transient computer usable medium having computer readable program code thereon, the computer readable program code comprising program code configured to:
receive, via an input operated by a processor, a first 3D surface geometry of a first object, a second 3D surface geometry of a second object, and a minimum clearance constraint;
calculate, using a processor, for an orientation of the first 3D surface geometry and an orientation of the second 3D surface geometry, a minimum clearance between the first 3D surface geometry and the second 3D surface geometry, the orientation of the second 3D surface geometry comprising three translational degrees of freedom and three rotational degrees of freedom;
compare, using a processor, the calculated minimum clearance to the minimum clearance constraint;
store, in a memory location in electrical communication with the processor, the orientation of the second 3D surface geometry and calculated minimum clearance if the calculated minimum clearance satisfies the minimum clearance constraint based on the comparing as a payload orientation with respect to the orientation of the first 3D surface geometry;
adjust, using a processor, each of the three translational degrees of freedom and three rotational degrees of freedom of the second 3D surface geometry through a series of six nested loops, each of the six nested loops adjusting a corresponding degree of freedom through a corresponding range of increments in a separate layer of the series and, for each increment, repeating the calculate, compare, and store operations for a corresponding orientation of the second 3D surface geometry; and
output, via a processor, the stored payload orientations.

42-60. (canceled)

61. A computer-implemented method of optimizing a packaging orientation of large irregular payloads, the method comprising:
receiving, via an input operated by a processor, a first 3D surface geometry of a first object, and at least a second 3D surface geometry of a second object (but possibly numerous other 3D surface geometries of other objects), and a required inter-object clearance constraint;
calculating, using a processor, for an orientation of the first 3D surface geometry and an orientation of each additional 3D surface geometry, an inter-object clearance between the first 3D surface geometry and each additional 3D surface geometry, the orientation of the additional surface geometries comprising three translational degrees of freedom and three rotational degrees of freedom between specified ranges for each degree of freedom;
comparing, using a processor, the calculated inter-object clearance to the input required inter-object clearance constraint;
storing, in a memory location in electrical communication with the processor, the orientation of each additional 3D surface and calculated inter-object clearance if the calculated inter-object clearance satisfies the required inter-object clearance constraint based on the comparing as a payload orientation with respect to the orientation of each 3D surface geometry;
adjusting, using a processor, each of the three translational degrees of freedom and three rotational degrees of freedom of the additional 3D surface geometries through a series of six nested loops per geometry, each of the six nested loops adjusting a corresponding degree of freedom through a corresponding range of increments in a separate layer of the series and, for each increment, repeating the calculating, comparing, and storing for a corresponding orientation of the additional 3D surface geometries; and
outputting, via a processor, the stored payload orientations.

62-77. (canceled)
